(19) United States
(12) Patent Application Publication
(10) Pub. No.: US 2025/0182422 A1
(43) Pub. Date: Jun. 5, 2025

(54) MODEL CUSTOMIZATION

(71) Applicants: Artur Vardanovich SAFARYAN, London (GB); CUSTOMUSE, INC., Wilmington, DE (US)

(72) Inventors: Artur Vardanovich SAFARYAN, London (GB); Daniil Sergeevich MIROSHNICHENKO, Saint-Petersburg (RU); Stefan Vitalievich VASKEVICH, aul Novaya Adygea (RU); Dmitry Vyacheslavovich BEZRUKOV, Toksovo (RU)

(73) Assignee: CUSTOMUSE, INC., Wilmington, DE (US)

(21) Appl. No.: 18/727,608

(22) PCT Filed: Jan. 11, 2022
(86) PCT No.: PCT/RU2022/000005

§ 371 Date: Jul. 9, 2024

(51) Int. Cl. G06T 19/20; G06F 40/30; G06T 17/20

(52) U.S. Cl. CPC G06T 19/20; G06T 17/20; G06F 40/30; G06T 2200/24; G06T 2219/024; G06T 2219/2012; G06T 2219/2024

(57) ABSTRACT

There is set forth herein: generating prompting data for prompting a user to define configuration data that specifies a model configuration; presenting the prompting data to the user; receiving model configuration data from the user subsequent to the presenting the prompting data; and generating an object representing model using data of the model configuration data received from the user.

### BACKGROUND

Embodiments herein relate generally to object representing models, and specifically to customization of object representing models.

Three-dimensional (3D) computer graphics are graphics that utilize a three-dimensional representation of geometric data (including objects) for rendering two-dimensional (2D) images. Resulting images can be displayed and viewed, e.g., as an animation. 3D graphics can include rendering of 3D object representing models. A 3D object representing model can include a mathematical representation of a 3D object. A 3D model can be displayed visually as a 2D image via 3D rendering. 3D modeling can refer to a process of developing a mathematical (e.g., coordinate-based) representation of an object (inanimate or living).

2D computer graphics are graphics that utilize a two-dimensional representation of geometric data (including objects for rendering) two-dimensional (2D) images. 2D graphics can include rendering of 2D object representing models. A 2D object representing model can refer to a geometric representation of an object as a 2D figure.

### BRIEF DESCRIPTION

There is set forth herein, according to one aspect, a method. The method can include, for example: generating prompting data for prompting a user to define configuration data that specifies a model configuration; presenting the prompting data to the user; receiving model configuration data from the user subsequent to the presenting the prompting data; and generating an object representing model using data of the model configuration data received from the user.

There is set forth herein a computer program product. A computer program product can include a computer readable storage medium readable by one or more processing circuit and storing instructions for execution by one or more processor for performing a method. The method can include, for example: generating prompting data for prompting a user to define configuration data that specifies a model configuration; presenting the prompting data to the user; receiving model configuration data from the user subsequent to the presenting the prompting data; and generating an object representing model using data of the model configuration data received from the user.

There is set forth herein a system. A system can include, for example a memory. In addition, the system can include one or more processor in communication with the memory. Further, the system can include program instructions executable by the one or more processor via the memory to perform a method. The method can include, for example: generating prompting data for prompting a user to define configuration data that specifies a model configuration; presenting the prompting data to the user; receiving model configuration data from the user subsequent to the presenting the prompting data; and generating an object representing model using data of the model configuration data received from the user.

### DRAWINGS

These and other features, aspects, and advantages set forth herein will become better understood when the following detailed description is read with reference to the accompanying drawings in which like characters represent like parts throughout the drawings, wherein:

FIG. 1 is a block diagram illustrating a system having manager system, user equipment (UE) devices, enterprise model rendering systems and a social media system according to one embodiment;

FIG. 2 is a flowchart illustrating a method for performance by a manager system interoperating with UE devices, a social media system, and enterprise model rendering systems according to one embodiment;

FIG. 3A depicts clustering analysis that can be performed with use of natural language processing of user assets according to one embodiment;

FIG. 3B depicts a predictive model according to one embodiment;

FIG. 3C depicts a predictive model according to one embodiment;

FIG. 4A depicts a user interface for use in custom model configuring according to one embodiment;

FIG. 4B depicts a user interface for use in custom model configuring according to one embodiment;

FIG. 4C depicts a user interface for use in custom model configuring according to one embodiment;

FIG. 4D depicts a user interface for use in custom model configuring according to one embodiment;

FIG. 4E depicts a user interface for use in custom model configuring according to one embodiment;

FIG. 5 is a block diagram illustrating a microservices system architecture for model generation according to one embodiment;

FIG. 6 is a flowchart illustrating a method for performance by a manager system interoperating with UE devices according to one embodiment;

FIG. 7 is a schematic block diagram illustrating a computer system according to one embodiment.

### DETAILED DESCRIPTION

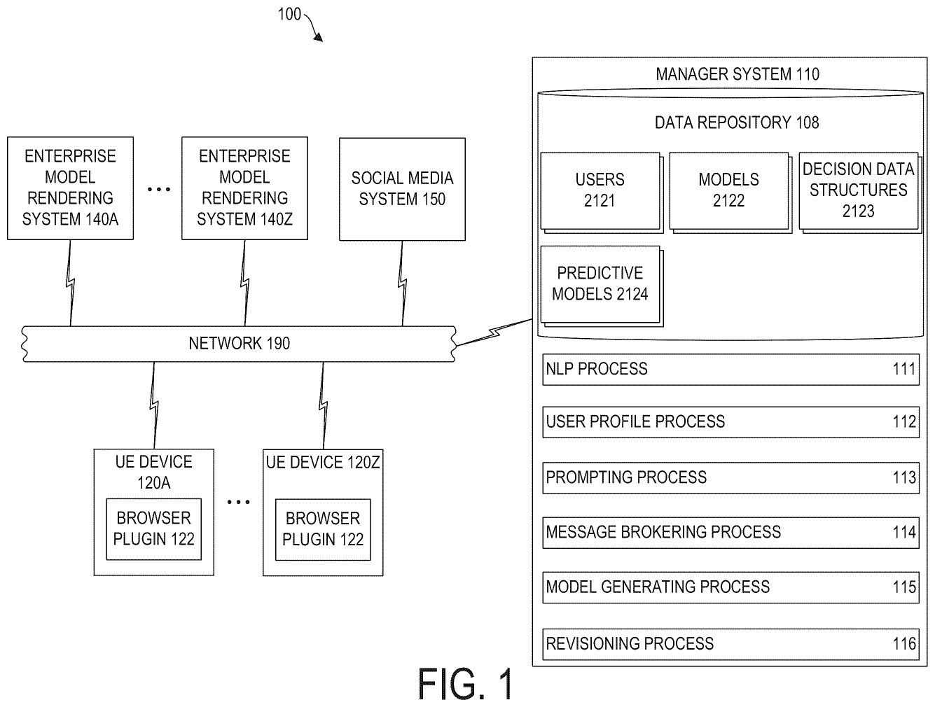

System 100 for use in customization of object representing models is shown in FIG. 1. System 100 can include manager system 110 having an associated data repository 108. User equipment (UE) devices 120A-120Z, enterprise model rendering systems 140A-140Z and social media system 150. Manager system 110, UE devices 120A-120Z, enterprise model rendering systems 140A-140Z and social media system 150 can be computing node-based devices connected by network 190. Network 190 can be a physical network and/or virtual network. A physical network can be for example a physical telecommunications network connecting numerous computing nodes or system such as computer servers and computer clients. A virtual network can for example, combine numerous physical networks or parts thereof into logical virtual network. In another example, numerous virtual networks can be defined over a single physical network.

In one embodiment, manager system 110 can be external and remote from each of UE devices 120A-120Z, enterprise model rendering systems 140A-140Z, and social media system 150. In one embodiment, manager system 110 can be co-located with one or more of at least one UE device of UE devices 120A-120Z, at least one enterprise system of enterprise model rendering systems 140A-140Z, and/or social media system 150.

UE devices 120A-120Z can be provided, e.g., by client computer devices. Each of the different UE devices of UE devices 120A-120Z can be associated to a different user. A respective UE device of UE devices 120A-120Z in one embodiment can be a computing node device provided by a client computer, e.g., a mobile device, e.g., a smartphone or tablet, a laptop, smartwatch or personal computer (PC) that runs one or more program, e.g., including a web browser for opening and viewing web pages. The frontend clients of system 100 and manager system 110, by operation of served user interface webpages served by manager system 110 can include several components including editors that allow users to import or create textures and other assets that can be used to customize models including 3D models.

The frontend can include features to facilitate user defining of model configuration data. The frontend in one embodiment can provide users with a selection tree-like interface to select a supported third-party platform (e.g., Decentraland®, Snapchat®, Instagram®, Shopify®, Zepeto®, Roblox®, Sandbox®, VRChat®, IMVU®, TikTok®, Sims4®) and then as selection tree that allows them to access a number of template 3D models for each platform. The user can then customize the 3D model adding color, textures and 3D “accessories”.

Users are also offered the ability to create a “profile” which stores the assets that they have created including 3D models that they have customized. These profiles are used to share customization data with other users. In one aspect a user can access another users' customized models to use as a base for their customization and the customized model will come with a hierarchical historical record of how it transformed from an original model to the specific instantiation that was selected.

In one aspect, UE devices 120A-120Z can run Three.js compliant browsers. Three.js can include JavaScript library and API for providing animated 3D computer graphics in a web browser with use of Web Graphics Library (WebGL). WebGL can include a JavaScript API for rendering interactive 2D and 3D graphics and for facilitating compositing HTML elements with graphical elements in a delivered webpage which can be configured to define a webpage. In one embodiment, an identifier of a candidate model can be provided by a rendering of stored model stored in models area 2122. UE devices 120A-120Z can include browser plug-ins 122 which can be installed as part of installation packages sent by manager system 110 to UE devices 120A-120Z on user registration into system 100. In one aspect, browser plug-ins 122 can be configured to send browsing data specifying webpages visited including content from webpages visited by the users for digestion by manager system 110. Manager system 110 can digest browsing data sent by UE devices 120A-120Z, e.g., by running of a natural language (NLP) process 111.

With further reference to FIG. 1, enterprise model rendering systems 140A-140Z can be model rendering systems provided by a plurality of different enterprise entities that render object representing models. Enterprise model rendering systems 140A through 140Z can include, e.g., systems provided by gaming enterprises, social media enterprises and the like. Embodiments herein recognize that different enterprise model rendering systems of enterprise model rendering systems 140A-140Z can require different format requirements for models that they are able to render. Enterprise model rendering systems of enterprise model rendering systems 140A-140Z can include examples of an enterprise model rendering system that is able to render and sometimes run animations with respect to an object representing model include, e.g., Decentraland®, Snapchat®, Instagram®, Shopify®, Zepeto® and Roblox®. Examples herein representative of different enterprise model rendering systems (which can be referred to as model platforms) are set forth with respect to the fictitious platforms herein referred to herein, e.g., of ABC model platform, MAGIC model platform, XYZ model platform, ACME model platform.

Manager system 110 can be configured to present prompting data to UE devices 120A-120Z that facilitates model customization by respective users of the UE devices 120A-120Z. Prompting data generated by manager system 110 can be output, e.g., on a visual and/or audio output device of respective UE devices 120A-120Z. Embodiments herein recognize that object representing models when customizable by user can augment communications participated in by users. Manager system 110 can define system for providing services to users of the system defined by manager system 110. The services can include facilitating custom model development by the users. In one aspect, manager system 110 can store certain model into data according to the user's custom model design. Then, manager system 110 can present prompting data to a second user that references certain model. The prompting data can reference the certain model by presenting a selectable rendering of the certain model. The second user in response to the prompting data presented to the second user can select the certain model as a template model on which to base a custom model design by the second user.

Custom configured object representing models associated to a user can be used by a user to express information, e.g., in terms of preferences of a user, social organization membership of a user, specific objectives of a user and the like. In many use cases, object representing models can define an improved communication facility as compared to text, e.g., in terms of ability to attract attention, retain attention and impact memory recall. In spite of the ability of object representing models to improve communications of users, embodiments herein recognize that the current state of the art does not permit either rapid generation of custom models or custom models that accurately present information desired to be presented by user.

Object representing models in many scenarios can provide more impactful communication mechanism than written text that in spite of capacities of users with existing technologies to create customized object representing models is severely limited. For example, in a typical video gaming scenario, the user may be presented an option to select only one of a limited set of stock candidate avatar models that can be selected to represent the gaming user. Because of the limited options available, the selected avatar model of the user can be misaligned to a desired avatar model which would have been selected by the user without limitations on the user's ability to customize a configured avatar model.

Embodiments herein address the scenario where a user who wants to participate in a second platform, the user must in general start the same process all over again, i.e., elect from a limited set of candidate stock avatar models but a different set of stock candidate avatar models from what was available on the first platform.

In one aspect, manager system 110 can be configured to intelligently generate prompting data. The prompting data can provide a user with an intelligently and adaptively selected to be aligned to determine preferences of the user. Intelligently and adaptively generating a limited set of menu options facilitates user customization of a model configuration aligned to user preferences and configured to optimize information communication by the user.

For intelligent generation of prompting data, manager system 110 can be configured to determine user profile data for users of system 100 and can use the user profile data to generate the prompting data. In one aspect, prompting data generated by manager system 110 can include prompting data that specifies one or more model of another user of system 100. The other user can be selected by way of a matching process in which a user profile of a current user is matched to another user of system. In one embodiment the other user can be selected based on user profile data of the other user having a threshold satisfying level of similarity to user profile data of the current user. Embodiments herein recognize that presenting prompting data to a user that specifies one or more model configured by another user can reduce the time required for a user to custom configure a suitable object representing model for conveyance of information of the current user and can also increase the accuracy with which a custom configured model of a current user conveys targeted information desired to be conveyed by the current user.

Embodiments herein also address the problem of model proliferation. Embodiments herein recognize that different enterprise model rendering systems that render object representing models have specialized formatting requirements. For a user to participate in first and second enterprise model rendering systems (model platforms) the user must enter a portal of the first model rendering system and create a model using configuration tools on the first portal, separately enter a portal of the second model rendering system and then create a model using the configuration tools of the second portal. For the reasons noted neither the first model nor the second model will be aligned to the communication objectives of the user. Further, the user must learn intricacies of multiple model development programs and the user will have multiple models to manage on different enterprise model rendering systems.

In another aspect, manager system 110 can include features that facilitate the adapting of a certain object representing model custom configured by a current user to be used on multiple enterprise model rendering systems. Accordingly, manager system 110 can include features to avoid user having to enter multiple different user interface portals for creation of multiple models in order to participate in multiple different enterprise model rendering systems.

As set forth herein, system 100 can include multiple features for accelerating custom configuration of an object representing model by a user and multiple features so that a custom configured model figured by a user accurately conveys information about a user desired to be conveyed by the user.

Data repository 108 can store various data. For example, data repository 108 can store a library of 3D models that have been created for a variety of platforms. Data repository 108 can also store user profiles and provide the sharing mechanism that not only allows peer-to-peer sharing of designs but also maintains historical records of modifications.

In users area 2121, data repository 108 can store data on users of system 100, including registered users of system 100. In users area 2121, data repository 108 can store registration data of a user. Registration data of a user can include, e.g., name information of the user, contact information of the user, address information of the user including messaging system and/or social media address information of a user, permissions of a user which specifies permissions which have been granted by the user to use personal data of the user including e.g., location data, UE device data including browser data, social media data, and various other types of data. User data in users area 2121 can also include, e.g., parameter values extracted from data assets associated to a user. Data assets associated to a user can include, e.g., social media posts of a user, social media messages of a user, browsing data of a user, application data of a user from applications running on a UE device of a user and the like. In users area 2121, there can also be stored data defining a history of actions of a user in using a user interface configured by manager system 110 and presented to the user. The user interface actions can include, e.g., model selection actions of a user and likes of a user, as well as posted content of a user.

Data repository 108 in models area 2122 can store a plurality of object representing models. Model data defining an object representing model can include (a) object shape representing data and (b) surface property data. A model herein can include a coordinate-based representation of an object, (e.g., inanimate or living) in simulated 2D or 3D space. The 3D model herein can include a coordinate based representation of the 3D object in simulated 3D space. In some embodiments, a 3D object shape representation of an object can be provided by a polygon mesh characterized by edges vertices and polygons. In some use cases, a model herein can include surface properties. Surface properties can include, e.g., textures. Textures herein can define, e.g., surface roughness, surface relief pattern, color, indicia pattern, and the like. Model data herein can include object representing model data that represents a 2D object and 2D space or a 3D object and 3D space. A model defined by model data herein can be subject to rendering, e.g., 2D rendering in the case of a 2D model or a 3D rendering in the case of the 3D model. In some use cases herein, models can be configured to perform movement known as animations. Rendering for interactive media, e.g., games and simulations, can be provided with use of frame rates of about 20 frames per second to about 120 frames per second in one embodiment. Rendering software may simulate visual effects such as depth of field, lens for layers or motion blur. These effects attempt to simulate visual phenomena resulting from optical characteristics of cameras in the human eye. Models herein can refer to 3D models or 2D models.

In one embodiment, 3D models herein can be polygon mesh-based models, wherein object shape representing data of a model can be provided by a polygon mesh. A polygonal mesh can be provided by a set of vertices, edges and faces. The faces can include, e.g., triangles, quadrangles or other simple convex polygons (polygons), as it simplifies rendering, but the meshes can also consist of the most common concave polygons, or polygons with holes. In other words, a polygonal mesh is a mathematical description of the physical shape of an object in three-dimensional space. A polygon mesh can provide a 3D shape representation of an object representing model.

In addition to the described object shape representing data, 3D models herein such as polygon mesh based models can be defined by surface property data. In one embodiment, the surface property data can define attributes for rendering the object shape representing data. In one embodiment, an object usually contains a description of surface properties which in one embodiment can be provided by instructions for rendering the object. In one embodiment, textures can be specified for surfaces of an object. In one aspect, 3D models can be rendered with use of shaders which perform differently in dependence on specified textures. Shaders for use in rendering a 3D model can include shaders written in GLSL (OpenGL Shading Language), i.e., a shader programming language, described in the OpenGL standard, supports data types often used in three-dimensional graphics (vectors, matrices). Shaders can be responsive to textures that are projected onto a UV scan (two-dimensional projection of a three-dimensional object). Textures can be used by a shader program to accurately represent surface properties such as specular, diffuse color, roughness, metallic, bumpiness and many others. In addition to the above mentioned “static” properties, a model may also have a set of properties responsible for object movement/animation. For example, a skeletal structure for a 3D model can be provided to define bone and joint movement to facilitate bone animation. Any movement or animation is usually measured in frames, which is equivalent to one described state. Animation playback speed can be 60 frames per second, according to one example. Animation can also be described as the sequential playback of animation frames of certain objects.

3D modeling herein can incorporate a variety of methodologies including polygonal modeling, curve modeling, and digital sculpting. Polygonal modeling can include use of polygon mesh based models as set forth herein. Curve modeling can include use of, e.g., non-uniform rational basis spline (NURBS) curves, patches, splines and geometric primitives. Digital sculpting can include use of, e.g., displacement digital sculpting, volumetric digital sculpting, and/or dynamic tessellation digital sculpting. For generation of 3D models, various 3D modeling software packages can be utilized, e.g., Blender®, Maya®, Houdini®, Cinema 4D®, Modo®, Rhinoceros®.

Models herein can be configured to be rendered on a display. Models herein can be subject to modification of the shape that they represent. For example, when an accessory is added to a model, the object representing shape data defining model (e.g., the polygon mesh in the case of polygon shape modeling) can be subject to modification so that the shape representing data represents the new shape of the model, with the addition of the accessory.

Model data stored in models area 2122 defining models can include, e.g., system models that are not associated to any specific user of system 100, as well as user associated models that are associated to certain users of system 100 and previously custom configured by those specific users. In presenting prompting data defined by model data to a user, manager system 110 can present both system models not associated to any specific user and user specific model that are associated to certain other users of system 100. In either case, manager system 110 can intelligently generate prompting data so that a user is presented with an intelligently selected set of candidate models that are pre-aligned to preferences of a user, thus accelerating the user's defining of model configuration data that specifies a model that communicates information desired to be communicated by the user. In one embodiment, system models can be loaded into models area 2122 by an administrator independent of use of a front-end user interface. In example, system models can be developed with use of a comprehensive range of development tools made available with use of 3D modeling software package independent of use of a front-end user interface. In one embodiment user models can include models previously configured by end users of system 100 in response to prompting data presented within served user interface webpages served by manager system 110. As a result of being custom designed by users of system 100 and manager system 110 user models can be tagged with user identifiers that specifies the user, e.g., registered user of system 100 and manager system 110 who custom designed the model in response to prompting data served by manager system 110. System models can be absent of user tags.

Data repository 108 and decision data structures area 2123 can include, e.g., decision tables and/or decision trees that facilitate in action decisions by manager system 110, e.g., in regard to the selection and generation of prompting data for prompting customized model configuration by a user.

Data repository 108 in predictive models area 2124 can include machine learning trained models that have been trained by manager system 110 to be responsive to query data for return of various predictions, e.g., predictions specifying likes and specifying preferences various users of system 100. Algorithms can be provided to gather information on what model users tend to use as template models for development of a custom model design often and correlate these template models to one another. For example, if a user selects model A as a template model, and many users who select Model A as a template model tend to select Model B as a template model, a user may be given the option with presented prompting data to select Model B. If a user searches for the model using search term specifying a first model under a certain genus, a user may be presented with a second species under the same genus. If a user logs in from geospatial region A, the user may be given options to select from popular models that are popular within region A.

Manager system 110 can run various processes. Manager system 110, for example, can run natural language processing (NLP) process 111, user profile process 112, prompting process 113, message brokering process 114, model generating process 115, and revisioning process 116.

Manager system 110 can run a natural language processing (NLP) process 111 for determining one or more NLP output parameter of a message. NLP process 111 can include, e.g., a topic classification process that determines topics of messages and outputs one or more topic NLP output parameter, a sentiment analysis process which determines sentiment parameters for a message, e.g., polar sentiment NLP output parameters, “negative,” “positive,” and/or non-polar NLP output sentiment parameters, e.g., “anger,” “disgust,” “fear,” “joy,” and/or “sadness” and outputs one or more sentiment NLP parameter, and/or or other classification process(es) for output of one or more other NLP output parameter, e.g., one of more “social tendency” NLP output parameter or one or more “writing style” NLP output parameter.

By running of NLP process 111 manager system 110 can perform a number of processes including one or more of (a) topic classification and output of one or more topic NLP output parameter for a received message (b) sentiment classification and output of one or more sentiment NLP output parameter for a received message or (c) other NLP classifications and output of one or more other NLP output parameter for the received message.

Topic analysis for topic classification and output of NLP output parameters can include topic segmentation to identify several topics within a message. Topic analysis can apply a variety of technologies e.g., one or more of Hidden Markov model (HMM), artificial chains, passage similarities using word co-occurrence, topic modeling, or clustering. Extracted topics can include general topics, as well as specific topics, including topics mapping to keywords.

Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.” In some use cases, manager system 110 processing an asset can include manager system 110 extracting a topic from an asset as well as a sentiment associated to the topic (e.g., whether the user exhibits a negative or positive sentiment (preference) with reference to the topic).

Manager system 110 running NLP process 111 can include manager system 110 returning NLP output parameters in addition to those specifying topic and sentiment, e.g., can provide sentence segmentation tags, and part of speech tags.

Manager system 110 running user profile process 112 can include manager system 110 iteratively updating a user profile for respective users of system 100. For iteratively updating a user profile, manager system 110 can iteratively update user data and can iteratively ascertain one or more preference of the user by examination of historical data of the user. In one aspect, user profile of a user can change over time, e.g., as additional assets associated to a user are processed, and/or as behavior patterns of a user change. In one aspect, attributes of a prompting data presented to a user for prompting defining of model configuration data can be dependent on dynamically changing profile data of a user which can be dynamically changing. Thus, prompting data of a user, like user profile data of a user can be dynamically changing.

Manager system 110 running user profile process 112 can iteratively determine a set of preferences of a user. Manager system 110 running user profile process 112 can include manager system 110 processing multiple data assets associated to a certain user. Multiple certain assets of the user can include, e.g., social media data of the certain user, e.g., as embodied by posts and/or message data of user within a social media system, browsing data of a user, i.e., data resulting from the user browsing to various websites including websites associated to different social media platforms and enterprise model rendering systems, UE device assets, i.e., assets residing on a client computer UE device of a user other than browsing data, and/or action history data of a user specifying a record of a user's action with respect to a user interface presented to the user by manager system 110 for custom model configuration by the user. Processing of the described assets associated to a certain user can include natural language processing by natural language processing (NLP process 111).

Manager system 110 running prompting process 113 can include manager system 110 intelligently presenting prompting data to a user to facilitate custom model configuration by the user. Manager system 110 running prompting process 113 can include manager system 110 intelligently generating prompting data for delivery to a user in dependence on a determined user profile and in dependence on determined preferences of a user.

In one aspect, manager system 110 running prompting process 113 can include manager system 110 presenting prompting data to a current user that prompts the current user to select (e.g., as a building block for a new custom-designed model) a previously designed and stored model associated to a certain other user of system 100. Manager system 110 can be configured so that the certain other user associated to the previously designed model referenced in the prompting data is selected based on the certain other user being determined to have preferences that exhibit a threshold level of similarity to preferences of the current user. Manager system 110 can be configured so that the certain other user associated to the previously designed model referenced in the prompting data is selected based on the certain other user being determined to have user profile data that exhibits a threshold level of similarity to preferences of the current user.

Manager system 110 running message brokering process 114 can include manager system 110 facilitating the publishing of model generation request messages generated in dependence on user defined model configuration data to a microservices message bus. In one aspect, manager system 110 can feature a microservices architecture that includes a microservices message bus. Messages published to the microservices message bus can be tagged with classification tags so that message data of messages can be processed by microservices subscribing to the classification tag. Messages published to a microservices message bus can be iteratively interrogated by one or more model generating microservice that is configured to be activated to process message data of a bus published message on recognition of a message classification tag that triggers its action. In one embodiment, messages published to a microservices message bus can be iteratively interrogated by a plurality of model generating microservices that are to be activated to process message data of bus published message on recognition of a message classification tag that triggers its action.

Manager system 110 running model generating process 115 can generate one or more object representing model in response to received user defined model configuration data, which user defined model configuration data can be defined in dependence on intelligently generated prompting data presented to the user. Manager system 110 running model generating process can generate one or more object representing model in one or more specialized model format that satisfies rendering requirements for rendering on one or more enterprise model rendering system. Manager system 110 running model generating process 115 can include manager system 110 generating one or more object representing model with use of one or more model generating microservice, and with use of the described message brokering process 114.

In one aspect, manager system 110 in dependence on user defined model configuration data can send a model generation request message tagged with a message classification tag and to a microservices message bus. Various model generating microservices that subscribe to one or more messages of one or more classification tag can be established to iteratively interrogate the microservices message bus for the presence of model generating request messages tagged with classification tags triggering their activation. The different model generating microservices interrogating the microservices message bus can be associated to different respective third-party enterprise model rendering systems of enterprise model rendering systems 140A-140Z. Embodiments herein recognize that respective ones of the enterprise model rendering systems 140A-140Z can require for rendering of a model that the model adhere to a predetermined specialized model format. The described different model generating microservices interrogating the described microservices message bus can include model generating microservices that generate models in a specified model format according to the requirements of one specific enterprise model rendering system of enterprise model rendering systems 140A-140Z.

In one embodiment, manager system 110 in response to and in dependence on user defined model configuration data can publish a model generation request message to a message services message bus that invokes the operation of a plurality of model generating microservices to generate multiple models of multiple different model formats, e.g., a first format adapted for rendering on a first enterprise model rendering system of enterprise model rendering systems 140A-140Z, and a second format adapted for rendering on a first enterprise model rendering system of enterprise model rendering systems 140A-140Z. For such functionality, manager system 110 can send a model generating request message to a microservices message bus that includes a first classification tag mapping to a classification tag subscription of the first model generating microservice, and a second classification tag mapping to a classification tag subscription of the second model generating microservice. Alternatively, for such functionality, manager system 110 can send a model generating request message to a microservices message bus that includes a classification tag subscribed to by each of the first and second microservice.

Manager system 110 running revisioning process 116 can include manager system 110 iteratively updating processes for generation of models in different model formats to continuously facilitate rendering of object representing models on different enterprise model rendering systems of enterprise model rendering systems 140A-140Z. Embodiments herein recognize that model formatting requirements associated to different enterprise model rendering systems 140A-140Z can be constantly changing over time. In one aspect, systematic revisioning of model generating processes can be facilitated with use of the microservices architecture set forth herein. For example, updates and various model generating microservices for generation of models specific to different respective enterprise model rendering systems can be performed independently and asynchronously, e.g., permitting asynchronous updating of a first model generating microservice without disruption of remaining model generating microservices. When an updated microservice for generating models adapted to be rendered on a first platform has been independently and asynchronously updated, it can simply be registered to a microservices message bus without disruption of any other model generating microservice associated to a different platform.

With use of the described microservices architecture, manager system 110 can be configured to be modular and extensible. With use of a microservices architecture in which different microservices are established for generation of models optimized for use in a specific enterprise model rendering system, handling of the different and varying and changing requirements can be performed systematically and reliably without reduced risk of downtimes for manager system 110 system upgrades. Embodiments herein include processes for systematically and iteratively updating microservices associated to different respective enterprise model rendering systems.

For generation of an object representing model in a certain model format a plurality of model generating microservices can be iteratively interrogating the described microservices message bus for messages having classification tags subscribed to by the particular model generating microservice. Manager system 110 running model generating process 115 can include manager system 110 generating object representing models in accordance with model configuration data defined by a user. Manager system 110 running model generating process 115 can include manager system 110 providing a plurality of model generating microservices for generating object representing models in different object representing model formats, wherein the different object representing model formats are adapted for rendering in different ones of enterprise model rendering systems 140A-140Z. For generation of a model formatted to be adapted for rendering in one particular enterprise model rendering system of enterprise model rendering systems 140A-140Z, the described model generating microservices can interrogate a microservices message bus for classification tags subscribed to by the particular model generating microservice.

Manager system 110 running model generating process 115 can include manager system 110 generating user customized models based on model configuration data defined by a user in dependence on prompting data presented to a user within a user interface presented to the user by manager system 110. In response to prompting data being presented to a user by running prompting process 113, a user can define model configuration data of the user. In response to receipt of model configuration data from the user, manager system 110 can present a model generation request to a microservices message bus. One or more model generating microservice capable of processing the request can respond to the model generation request message by generating a model adapted for rendering on or more model rendering system of enterprise model rendering systems 140A-140Z. In one example herein, model configuration data of a user can include, e.g., (i) a model identifier, i.e., design-ID, specifying the model, (ii) a user identifier; (iii) surface properties parameter values; (iv) accessories parameter values and (v) template model modification data which references a selected template model and modification stages for modification of the template model, as well as (vi) identifiers for one or more target model rendering system. The item (vi) can be provided in one example by an identifier of a required file format of the target model rendering system.

Model generating microservices can perform a variety of processes including (a) obtaining parameter values specifying any accessories and/or surface properties defined by a user in the model configuration data; (b) obtaining file data defining a template model specified by user in user defined configuration data; (c) running script or alternative 3D modeling software to modify 3D object shape representing data in accordance with the accessory specified in the configuration data (e.g., in the case of a polygon mesh, modifying the polygon mesh of the template model); (d) running script of alternative 3D modeling software to remove and replace surface properties of the template model as modified by any 3D shape modification (if any), (e) formatting the resulting transformed and generated model data into the format specified by a target model rendering system, and (f) exporting the formatted generated model for storage into storage (and re-use as a future template model) and for sending to the user. Actions of the above actions (a)-(f) can change over time in dependence on updates to model specification documents iteratively posted on enterprise model rendering systems of enterprise model rendering systems 140A-140Z.

Manager system 110 running revisioning process 116 can iteratively update respective ones of model generating microservices so that model generating microservices run by model generating process 115 remain current. Embodiments herein recognize that enterprise model rendering systems of enterprise model rendering systems 140A-140Z can iteratively publish specification documents that specify requirements for object representing models to be integrated in the respective enterprise model rendering systems. Respective model generating microservices herein can perform processes to generate object representing models based on user-defined model configuration data.

Manager system 110 in performing revisioning process 116 can iteratively crawl enterprise model rendering systems 140A-140Z for updates to model specification documents published on enterprise model rendering systems 140A-140Z. Manager system 110 in one aspect in performing revisioning process 115 can run a model specification documents parser that parses text from published model specification documents that are published and posted on enterprise model rendering systems 140A-140Z. Manager system 110 running revisioning process 116 can iteratively crawl enterprise model rendering systems 140A-140Z to identify updates to posted model specification documents and can parse an updated model specification document to identify required changes to the actions (a)-(f) described herein and can appropriately modify a current model generating microservice so that one or more of the actions (a)-(f) (or another action) is updated in accordance with the requirements of the posted model specification document crawled and identified by manager system. Embodiments herein recognize that different ones of enterprise model rendering system 140A-140Z can have different and changing data size limits for models that they can render. In another aspect, embodiments herein recognize that different ones of enterprise model rendering system 140A-140Z can have different and changing bone structure requirement for models that they render, and different and changing requirements for the models that they render in terms of, e.g., numbers of polygons, numbers of triangles, and numbers of vertices. In another aspect, embodiments herein recognize that different ones of enterprise model rendering system 140A-140Z, can have different and changing requirements in terms of shaders, texture maps, animation, and project file sets.

Embodiments herein recognize that the above actions (a)-(f) for performance by a model generating microservice can change over time in dependence on updates to model specification documents iteratively posted on enterprise model rendering systems of enterprise model rendering systems 140A-140Z. Manager system 110 in performing revisioning process 116 can iteratively crawl enterprise model rendering systems 140A-140Z for updates to model specification documents published on enterprise model rendering systems 140A-140Z. Manager system 110 in one aspect can run a model specification documents parser that parses text from published model specification documents that are published and posted on enterprise model rendering systems 140A-140Z. Manager system 110 running revisioning process 116 can iteratively crawl enterprise model rendering systems 140A-140Z to identify updates to posted model specification documents and can parse an updated model specification document to identify required changes to the actions (a)-(f) described herein and can appropriately modify a current model generating microservice so that one or more of the actions (a)-(f) (or another action) is updated in accordance with the requirements of the posted model specification document crawled and identified by manager system 110.

Manager system 110 running revisioning process 116 can assure that model generating microservices for performing model generating process 115 are iteratively updated to be able to generate object representing models that are adapted for use according to current and updated requirements for formatting and use in a particular enterprise model rendering systems of enterprise model rendering systems 140A-140Z.

Social media system 150 can include a collection of files, including for example, HTML files, CSS files, image files, and JavaScript files. Social media system 150 can be a social website such as FACEBOOK® (Facebook is a registered trademark of Facebook, Inc.), TWITTER® (Twitter is a registered trademark of Twitter, Inc.), LINKEDIN® (LinkedIn is a registered trademark of LinkedIn Corporation), or INSTAGRAM® (Instagram is a registered trademark of Instagram, LLC). Computer implemented social networks incorporate messaging systems that are capable of receiving and transmitting messages to client computers of participant users of the messaging systems. Messaging systems can also be incorporated in systems that that have minimal or no social network attributes. A messaging system can be provided by a short message system (SMS) text message delivery service of a mobile phone cellular network provider, or an email delivery system. Manager system 110 can include a messaging system in one embodiment. During a process of registration wherein a user of system 100 registers as a registered user of system 100, a user sending registration data can send with permission data defining the registration data a permission that grants access by manager system 110 to data of the user within social media system 150. On being registered, manager system 110 can examine data of social media system 150 e.g., to determine whether first and second users are in communication with one another via a messaging system of social media system 150. A user can enter registration data using a user interface displayed on a client computer device of UE devices 120A-120Z.

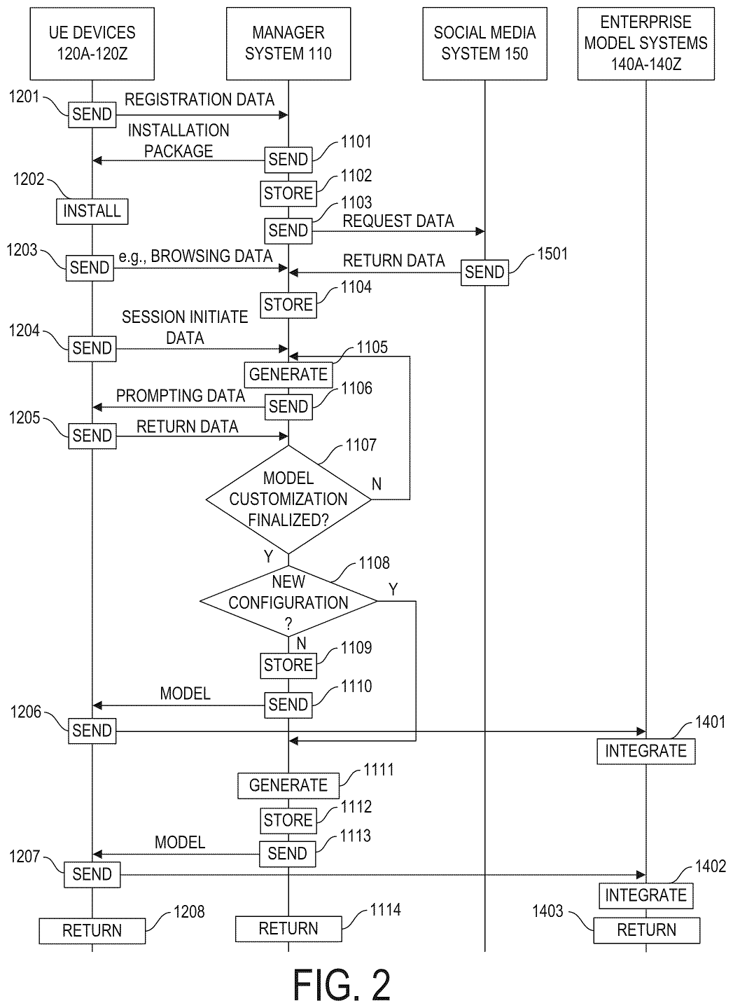

A method for performance by manager system 110 interoperating with UE devices 120A-120Z and social media system 150 is set forth in reference to the flowchart of FIG. 2. At block 1201, UE devices 120A-120Z can be sending registration data for receipt by manager system 110. On receipt of the registration data, manager system 110 at send block 1101 can send an installation package to respective ones of UE devices 120A-120Z. Installation packages sent at block 1101 can include, e.g., libraries and executable code to facilitate the participation of UE devices 120A-120Z in system 100. At store block 1102, manager system 110 can store in users area 2121 registration data sent by a user at block 1201. On receipt of the installation package by UE devices 120A-120Z, UE devices 120A-120Z can install their respective installation packages at block 1202. In one embodiment, an installation package can include a browser plug-in which facilitates the transmission of browsing data of a user to manager system 110 for use in manager system 110 in determining preferences of users.

Registration data stored at block 1102 can include, e.g., name, address, social media account information, other contact information, biographical information, background information, preferences information, and/or permissions data e.g., can include permissions data allowing manager system 110 to query data of a social media account of a user provided by social media system 150 including messaging system data and any other data of the user. Entered registration data can include, e.g., permissions data. Permissions data can include permissions data allowing manager system 110 to query data of a social media account of a user provided by social media system 150 including messaging system data and any other data of the user. Volunteered data of a user can be included within registration data. Volunteered data can include demographic data, e.g., data respecting geospatial coordinates of residence, educational level, and location of a user. Location data of a user can include, e.g., geospatial coordinates of residence and/or geospatial coordinates of a location of a user, e.g., as derived from a login IP address of a user. When a user opts-in to register into system 100 and grants system 100 permission to access data of social media system 150, system 100 can inform the user as to what data is collected and why, that any collected personal data may be encrypted, that the user can opt out at any time, and that if the user opts out, any personal data of the user is deleted.

On completion of store block 1102, manager system 110 can proceed to send block 1103. At send block 1103, manager system 110 can send request data to social media system 150 for asset data, e.g., posts data and/or message data for registered users who have sent registration data at block 1201. Social media system 150 at send block 1501 can send return data defined by return asset data. At block 1203, e.g., responsively to a request for manager system 110 or by configuration UE devices 120A-120Z can send various asset data, e.g., browsing data, to manager system 110 for consumption by manager system 110. Asset data sent at block 1203 can also include such asset data as application data from one or more applications running on UE devices 120A-120Z such as calendar applications and other applications.

In response to the received asset data sent at block 1501 and 1203, manager system 110 at store block 1104 can store the received asset data into users area 2121 of data repository 108. With the storage of asset data into users area 2121, manager system 110 can subject the asset data to various processing including natural language process. Multiple certain assets of the user defining asset data can include, e.g., social media data of the certain user, e.g., as embodied by posts and/or message data of user within a social media system, browsing data of a user, i.e., data resulting from the user browsing to various websites including websites associated to different social media platforms and enterprise model rendering systems, UE device assets, i.e., assets residing on a client computer UE device of a user other than browsing data, and/or action history data of a user specifying a record of a user's action with respect to a user interface presented to the user by manager system 110 for custom model configuration by the user. Processing of the described assets associated to a certain user can include natural language processing by natural language processing (NLP process 111). The performed natural language processing can include natural language processing to extract topic parameter values and/or sentiment parameter values. Thus, natural language processing can be employed to identify topics of interest to a user, and the user's sentiment toward the topic (e.g., negative to positive). Assets subject to natural language processing at block 1104 for extraction of topic and/or sentiment parameter values can include assets stored within users areas 2121 and or models areas 2122 recorded as a result of a user interacting with manager system 110. Such assets can include, e.g., an action history of the user in respect to interactions with manager system 110, any text based messages sent by a messaging system supported by manager system 110 to another user of manager system 110, hashtags assigned to user models custom designed by a user, and/or posts in relation to models including other user models.

At block 1204, a UE device of UE devices 120A-120Z, e.g., UE device 120A can send session initiate data for initiating a model creation session responsively to receipt of the session initiate data. In response to the receipt of the session initiate data, manager system 110 can proceed to block 1105. At block 1105, manager system 110 can generate prompting data for prompting the user to define configuration data defining a configuration of a model. At generate block 1105, manager system 110 can generate prompting data that specifies a plurality of candidate models for selection by the current user. The candidate models can define a limited set of adaptively determined models.

By specifying a limited set of candidate models within prompting data presented to a user, e.g., M system models and/or N user models, manager system 110 can avoid the situation where the user is overwhelmed with too many possibilities to select from, and thus can quickly arrive at model configuration. By being adaptive, candidate models can be preconfigured and intelligently selected to be aligned with the determined preferences of the current user which preferences can be iteratively changing. For example, based on new asset data generated by a user over time, preferences of a user can change over time. In the performance of generating prompting data at generate block 1105, manager system 110 can include or exclude models from the set of candidate models in dependence on determined preferences of a user and/or in dependence on other factors. As noted the number of candidate models presented to a user with prompting data can be limited. In one example, the prompting data can specify a single system model and/or a single user model. In other examples, there can be specified more than one candidate system model and/or more than one user model within prompting data presented to a user.

Candidate models that are specified to user with prompting data sent at block 1105 can include system models that are not associated to any specific user of system 100 and/or can include user models that have been previously configured by one or more user of system 100. In either case, selected models are selected for inclusion in the set of candidate models can be selected in dependence on determined preferences of a user and/or in dependence on other factors for facilitation of rapid configuration of a new custom model by the user.

Manager system 110 for generation of prompting data at block 1105 can include manager system 110 interrogating profile data of the current user and of other users of system 100 wherein the described profile data specifies preferences of users, e.g., across a plurality of topics classifiers. In one embodiment, manager system 110 can employ clustering analysis at generate block 1105. Clustering analysis can be applied, e.g., to identify user preferences across different topics and clustering analysis can be further employed to identify first and second different users having user profiles that exhibit a threshold level of similarity.

As to the current user sending session initiate data at block 1204 manager system 110 at generate block 1105 can determine by clustering analysis that a second user of the system has a user profile exhibiting a threshold level of similarity with the current user. Manager system 110 can thus select models of the second user for inclusion in the set of candidate models for specification in the prompting data generated at generating block 1105. Manager system 110 in response to completion of generate block 1105 can proceed to block 1106. In one embodiment, manager system 110 can apply Eq. 1 and/or Eq. 2 below in determining whether to include an archived model stored in models area 2122 in a set of one or more candidate model to specify to a user within prompting data.

$$RS = FS 1 W 1 + FS 2 W 2 + FS 3 W 3 + FS 4 W 4 + FS 5 W 5 \qquad ( Eq . 1 )$$

Eq. 1 is a predictive model provided by an algorithmic formula for determining whether to include an archived system model of models area 2122 not associated to any user within a set of candidate models to be specified to a user within prompting data. Referring to Eq. 1, RS can be a total predicted relevance score for the archived model, FS1-FS4 are factors contributing to the relevance score and W1-W4 can be weights associated to the various factors. Manager system 110 can score all available system models of models area 2122 and can select the M highest scoring models as the models to include within a set of candidate system template models.

According to one embodiment, FS1 can be a popularity factor for evaluating a model for inclusion as a candidate template model to be delivered to a user. Manager system 110 can assign scoring values under factor FS1 in dependence on a popularity of the model. In one embodiment, popularity of a model can be measured in terms of likes accumulated to a model and/or a number of remix requests for a model. Manager system 110 in models area 2122 can accumulate popularity statistics for all models stored in models area 2122.

TABLE A

| | | Timestamp | | | |
|---|---|---|---|---|---|
| Row | Model | (creation time) | Likes | Remixes | Remix rate |
| 145 | M067 | XX | XX | XX | XX |
| 146 | M079 | XX | XX | XX | XX |
| 147 | M122 | XX | XX | XX | XX |

Referring to Table A, manager system 110 for each model stored in models area 2122 can record a timestamp specifying a creation time for the model, the number of likes recorded for the model, the number of remixes of the model, and the remix rate for the model. A user interface herein that presents candidate models for selection as a template model for creation of a new model can permit users to record “likes” for candidate models whether they are selected or not selected as a template model for creation of a new model. Manager system 110 can be configured to record likes that have been registered by all users. A user using a user interface herein can select a candidate model as a template model for creation of a new custom model. Manager system 110 can be configured to record each instance of a selection of a model as a remix model (template model), and can add to the count of remixes in the Table A data each time that particular model is selected as a template model by any user. Manager system 110 using a timestamp associated to a model can count how many times a new model has been selected as a template model within time T (e.g., 24 hours) from the time of creation of a model to record a remix rate of a model (the rate at which the model is selected as a template model). Manager system 110 under factor FS1 can bias scoring values under factor FS1 upward from a baseline value in the case of a higher than baseline number of likes, higher than baseline number of remixes, and/or higher than baseline remix rate. Manager system 110 under factor FS1 can bias scoring values under factor FS1 downward from a baseline value in the case of a lower than baseline number of likes, lower than baseline number of remixes, and/or lower than baseline remix rate for the model being subject to evaluation for inclusion as a candidate model.

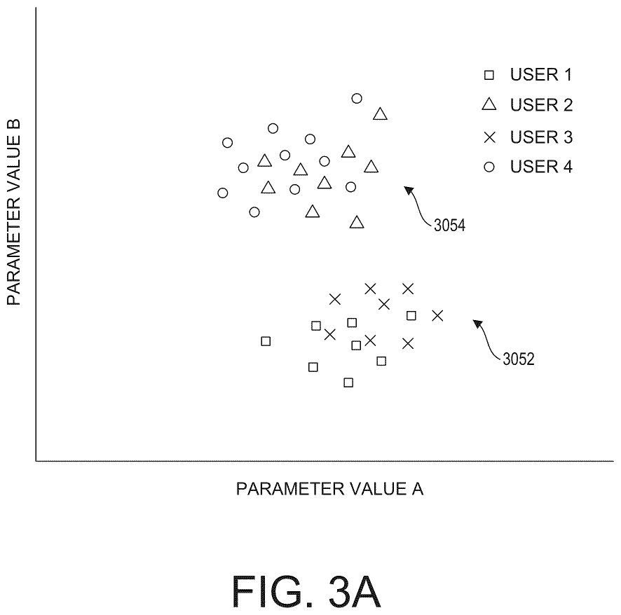

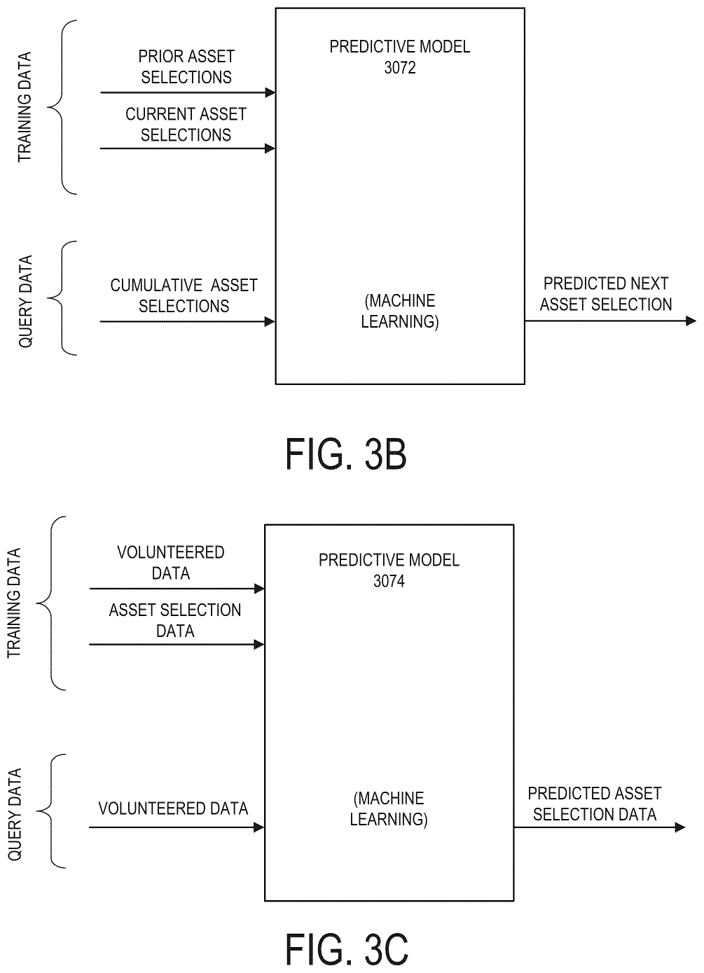

With further reference to Eq. 1, factor FS2 can be a user profile factor which can be dependent on user preferences. In applying factor F2, manager system 110 can apply the popularity data for the model being evaluated as summarized in Table A but can exclude likes and remixes from users who are not in a common user profile cluster with the certain user. Clustering analysis in one embodiment is described with referenced to FIG. 3A. For determining clusters of users dependent on user profile and preferences, a set of observations can be plotted on a scatterplot having first and second dimensions. In one embodiment the set of observations can map to a set of assets of each user returned at block 1203 and block 1501 subject to natural language processing for extraction of topic and sentiment. In one example, the X axis data values can specify topic strength of a topic (e.g., in terms of frequency of topic extraction for a topic within an asset) and the plotted Y axis data values can specify strength of sentiment associated to the topic for the asset (e.g., 0.0 for lowest negative sentiment, 0.5 for neutral sentiment, 1.0 for highest positive sentiment). In FIG. 3A, hypothetical illustrative results are shown for four users for one arbitrary topic. It will be seen that a set of P “key” topics (e.g., where P is an integer ranging from about 10 to about 1000) can be selected and the results aggregated from the P topics and expanded to include all users of system 100. Referring to FIG. 3A, first and second clusters, e.g., clusters 3052 and 3054 can be identified by clustering analysis, e.g., with use of K-means clustering. Manager system 110 under factor FS3 can bias scoring values under factor FS3 upward from a baseline in the case of a higher than baseline number of likes, higher than baseline number of remixes, and/or higher than baseline remix rate excluding likes and remixes from users who are not in a common user profile cluster with the current user. Manager system 110 under factor FS2 can bias scoring values under factor FS2 downward from a baseline in the case of a lower than baseline number of likes, lower than baseline number of remixes, and/or lower than baseline remix rate for the model being subject to evaluation for inclusion as a candidate model excluding likes and remixes from a users who are not in a common user profile cluster with the current user.

With further reference to Eq. 1 factor FS3 can be a prior selections factor. In one aspect, system 100 can be trained with use of machine learning to predict next asset selections of users in dependence on prior asset selections of user. FIG. 3B depicts a predictive model 3072 which can be trained with use of machine learning to predict a next asset, e.g., model selection of a user. Predictive model 3072 can be trained with iterations of training data and once trained can be capable of returning predictions as to a next asset selection of user. Each iteration of training data can include (a) parameter values specifying a current (most recent) asset selection by a user in combination with (b) parameter values specifying J prior asset selections of the user. Manager system 110 can apply a new iteration of training data to predictive model 3072 each time any user of system 100 makes an asset (e.g., model, accessory, material, or color) selection. A supervised learning machine learning model is defined wherein prior selections are trained on the known output of a next selection. Trained as described, predictive model 3072 is able learn a relationship between prior asset selections of a user and a next asset selection of a user. Once trained, predictive model 3072 can be configured to respond to query data. Query data for querying predictive model 3072 can include a set of cumulative asset selections of the user, e.g. the J most recent asset selections of the current user. Result data for predictive model 3072 can include assigned confidence levels associated to each archived model of models area 2122 that the archived model of models area 2122 will be the next asset selection of the user. Manager system 110 applying scoring values under factor FO3 can apply scoring values in dependence on the predicted level of confidence that the model being evaluated will be the next selected model of the user as determined by querying predictive model 3072.

With further reference to Eq. 1, factor FS4 can be a volunteered data factor, in which a next model selected data of a user can be predicted based on volunteered data of a user, e.g., demographic data including location data of the user. FIG. 3C depicts predictive model 3074 which can be trained with iterations of training data. Iterations of training data can include (a) volunteered data of a user as set forth herein, including location data, and (b) asset selection data of the user. With each new asset selection of any user of system 100 a new iteration of training data can be applied to predictive model 3074 so that predictive model 3074 learns of a relationship between volunteered data and asset selection including model selections of users. Once trained, predictive model 3074 can respond to query data. Query data for querying predictive model 3074 can include volunteered data of the user, e.g., location data of the user and optionally additional volunteered data of the user. In response to the applied query data, predictive model 3074 can assign levels of confidence to archived models of models area 2122 that specifies the likelihood that the respective models will be selected as the next selected model. Manager system 110 can assign scoring values under factor FS4 in proportion to an assigned level of confidence assigned by predictive model 3074 that the current model being evaluated for inclusion in a set of candidate models will be the next selected model.

With further reference to Eq. 1 factor FS5 can be a time factor. Manager system 110 can apply scoring values under factor FS4 according to time from creation so that lower scoring values are applied for models under the factor as the model ages.

$$RO = FO 1 W 1 + FO 2 W 2 + FO 3 W 3 + FO 4 W 4 + FO 5 W 5 + FO 6 W 6 \qquad ( Eq . 2 )$$

Eq. 2 is a predictive model provided by an algorithmic formula for determining whether to include an archived user-associated model of models area 2122 associated to another user within a set of candidate models to be specified to a user within prompting data. Referring to Eq. 2, RO can be a total predicted relevance score for the archived user-associated model, FO1-FO4 are factors contributing to the relevance score and W1-W4 can be weights associated to the various factors. Manager system 110 can score all available user associated models of models area 2122 and can select the N highest scoring user-associated models as the models to include within a set of candidate user template models.

According to one embodiment, FO1 can be a model popularity factor for evaluating a user-associated model for inclusion as a candidate template user model to be delivered to a user. Manager system 110 can assign scoring values under factor FO1 in dependence on a popularity of the model. In one embodiment, popularity of a model can be measured in terms of likes accumulated to a model and/or a number of remix requests for a model (the number of times the model has been selected as a template model for use as a base model in creation of a new custom model design). Manager system 110 in models area 2122 can accumulate popularity statistics for all models stored in models area 2122. Referring to Table A, manager system 110 for each model stored in models area 2122 can record a timestamp specifying a creation time for the model, the number of likes recorded for the model, the number of remixes of the model, and the remix rate for the model. A user interface herein that presents candidate models for selection as a template model for creation of a new model can permit users to record “likes” for candidate models whether they are selected or not selected as a template model for creation of a new model. Manager system 110 can be configured to record likes that have been registered by all users. A user using a user interface herein can select a candidate model as a template model for creation of a new custom model. Manager system 110 can be configured to record each selection of a model as a remix of the model, and can add to the count of remixes in the Table A data each time that particular model is selected as a template model by any user. Manager system 110 using a timestamp associated to a model can count how many times a new model has been selected as a template model within time T (e.g., 24 hours) from the time of creation of a model to record a remix rate of a model. Manager system 110 under factor FO1 can bias scoring values under factor FO1 upward from a baseline value in the case of a higher than baseline number of likes, higher than baseline number of remixes, and/or higher than baseline remix rate. Manager system 110 under factor FO1 can bias scoring values under factor FO1 downward from a baseline value in the case of a lower than baseline number of likes, lower than baseline number of remixes, and/or lower than baseline remix rate for the user-associated model being subject to evaluation for inclusion as a candidate model.

With further reference to Eq. 2, factor FO2 can be user profile factor which can be dependent on user preferences of the current user. In applying factor FO2, manager system 110 can apply scoring values under factor FO2 in dependence on level of similarity in a user profile of the current user relative to user profile of the user associated to the user model being evaluated for inclusion in set of candidate models. Manager system 110 can apply scoring values under factor FO2 in proportion to a level of similarity of the user profile of the current user to a user profile of the user associated to the model being evaluated for inclusion in a set of candidate models. Clustering analysis can be applied for determining a level of similarity between users. Referring to the clustering analysis depicted in FIG. 3A, manager system 110, wherein the current user is User 1, can apply higher scoring values under factor FO2 in the case the model being evaluated is associated to User 3 (stronger similarity based on cumulative Euclidian distance), than in the case the model being evaluated of inclusion in a set of candidate models defining prompting data is associated to User 4 (weaker similarity based on cumulative Euclidian distance).

With further reference to Eq. 2, factor FO3 can be a prior selections factor. Once trained, predictive model 3072 described in reference to FIG. 3B can be configured to respond to query data. Query data for querying predictive model 3072 can include a set of cumulative asset selections of the user, e.g., the J most recent asset selections of the current user. In response to applied query data, predictive model 3072 can output result data. Result data for predictive model 3072 can include assigned confidence levels associated to each archived model of models area 2122 that the archived model of models area 2122 will be the next asset selection of the user. Manager system 110 applying scoring values under factor FO3 can apply scoring values in dependence on the predicted level of confidence that the model being evaluated will be the next selected model of the user as determined by querying predictive model 3072.

With further reference to Eq. 2, factor FO4 can be a volunteered data factor, in which a next model selected data of a user can be predicted based on volunteered data of a user, e.g., demographic data including location data of the user. FIG. 3C depicts predictive model 3074 which can be trained with iterations of training data. Iterations of training data can include (a) volunteered data of a user as set forth herein, including location data, and (b) asset selection data of the user. With each new asset selection of any user of system 100 a new iteration of training data can be applied to predictive model 3074 so that predictive model learns of a relationship between volunteered data and asset selection including model selections of users. Once trained, predictive model 3074 can respond to query data. Query data for querying predictive model 3074 can include volunteered data of the user, e.g., location data of the user and optionally additional volunteered data of the user. In response to the applied query data predictive model can assign levels of confidence to archived models of models area 2122 that specifies the likelihood that the respective models will be selected as the next selected model. Manager system 110 can assign scoring values under factor FS4 in proportion to assigned level of confidence assigned by predictive model 3074 that the current model being evaluated for inclusion in a set of candidate models will be the next selected model.

With further reference to Eq. 2, factor FO5 can be a time factor. Manager system 110 can apply scoring values under factor FO4 according to time from creation so that lower scoring values are applied for models under the factor as the model ages.

With further reference to Eq. 2, factor FO6 can be user popularity factor. User popularity can refer to the popularity of the user associated to the model being subject to evaluation for inclusion in a set of candidate models. While a model might be new, manager system 110 can assign high scoring values under factor FO6 in the case the user associated to the model has significant popularity. In applying scoring values under factor FO6, manager system 110 can examine statistics of Table A but can aggregate the popularity statistics recording likes, remixes, and remix rate, for all models of the user associated to the model being subject to evaluation. Manager system 110 can apply scoring values under factor FO6 in dependence on the current user's interaction with other models of the user associated to the model being subject to evaluation, and can upwardly bias scoring values under factor FO6 if the current user likes or remixes models of the user associated to the model being evaluated with a threshold exceeding frequency.

At block 1106, manager system 110 can send the prompting data to the user device to the UE device 120A of the current user. Manager system 110 sending prompting data at block 1106 can include manager system 110 sending a web-based user interface that specifies to the users the candidate models described with reference to generate block 1105. The candidate models as explained herein can include both intelligently selected template models not associated to the new user in one or more user associated to the user one or more user associated model associated to a second user of the system having user profile determined to exhibit a threshold level of similarity with the current user.

The models included in the set of candidate models can also be selected in dependence on user profile data of the current user. In one example, using clustering analysis as explained with reference to FIG. 3A, a user can be classified into a certain classification (cluster) of users and model options can be selected with use of a decision data structure as set forth in reference to Table B below

TABLE B

| | User profile | Candidate | Accessories | Color | Material |
|---|---|---|---|---|---|
| | classification | template | configurator | configurator | configurator |
| Row | (cluster) | models | menu options | menu options | menu options |
| 1 | I (e.g., | Models list | Accessories list | Colors list | Materials list |
| | cluster 3052) | ML067 | AL078 | CL099 | TL088 |
| 2 | II (e.g. | Models list | Accessories list | Colors list | Materials list |
| | cluster 3054) | ML034 | AL108 | CL239 | TL098 |
| 3 | III | Models list | Accessories list | Colors list | Materials list |
| | | ML022 | AL305 | CL050 | TL182 |

With prompting data transmitted to the user as described, the user is enabled to rapidly and accurately define model configuration data that accurately presents information desired for presentment by the certain user. In reference to Table B, menu options defined by a set of candidate models, and/or expressed within an configurator such as configurator 3012, configurator 3014, configurator 3016, and/or configurator 3018 of user interface 3000 can be dependent on a user profile (e.g., preference based) cluster classification of a user, which cluster classification can be dependent on a result of subjecting asset data of a user (e.g., social media posts data, message data, calendar data, browsing history data) to natural language processing, e.g., for topic and/or sentiment extraction. Referring to Table B, the models listed in the respective models lists of the candidate template models column in one embodiment can define the models specified as candidate models with presented prompting data. The respective models lists of the candidate template models column in one embodiment can be used to score models for evaluation under factor FS2 of Eq. 1 and/or FO2 of Eq. 2 (inclusion of an evaluated model on the list biases a scoring value under the factor upward). Referring to Table B, the options listed in the respective accessories, colors, and materials lists can define the respective accessories, colors, and materials options presented to the user with presented prompting data. Thus, it is seen that respective accessories, colors, and materials options presented to the user with presented prompting data can change in dependence on user profile data of a user, which can be dependent on preferences of a user, which can be dependent on a result of subjecting asset data of a user to natural language processing to extract e.g., topic and/or sentiment parameter values.

Based on prompting data generated at block 1105, manager system 110 can proceed to block 1106. At block 1106, manager system 110 can send prompting data for presentment on a UE device, e.g., UE device 120A of the current user. In the described example, the prompting data sent at block 1106 can include prompting data that specifies a plurality of candidate models for selection which can include template models not associated to any user in model and user associated template models. The prompting data can include identifiers of the candidate models. In one embodiment the identifiers of the candidate models can include renderings of the candidate models. In one embodiment, generating prompting data can include, e.g., identifying and/or determining data to send in order to prompt a user. Presenting prompting data herein can include sending data to user to prompt a user. In one particular embodiment prompting data can be sent to a user with use of user interface defining webpages.

In one embodiment, selectable identifiers for candidate models defining prompting can include, e.g., image based representations of the candidate models, such as rendered representations of models defining candidate models for selection by a user. In one embodiment, UE devices 120A-120Z can run Three.js compliant browsers, and manager system 110 can run a Three.js compliant application program interface (API) for serving user interface defining webpages. Three.js can include JavaScript library and API for providing animated 3D computer graphics in a web browser with use of Web Graphics Library (WebGL). WebGL can include a JavaScript API for rendering interactive 2D and 3D graphics and for facilitating compositing HTML elements with graphical elements in a delivered webpage which can be configured to define a webpage. In one embodiment, an identifier of a candidate model can be provided by a rendering of stored model stored in models area 2122. In one embodiment, representations of models for inclusion in prompting data can include lightweight images conveniently stored as .png images within the models area 2122. Models area 2122 can include model data defining various models. There can be stored models area 2122, UUIDs for each new model stored generated and stored in data repository 108. Associated to each new model there can be stored a lightweight two-dimensional image, e.g., a .png image representing an object representing model. These lightweight images, e.g., .png images, can be configured to be readily integrated into user interface defining webpages for delivery and rendering on a user's UE device, e.g., UE device 120A in the described scenario. In one embodiment, as noted model data of models area 2122 can be rendered to form part of a web based user interface presented to a user, e.g., within use of a Three.js compliant browser on a frontend defined by a UE device and associated server-side API at manager system 110.

Prompting data sent at block 1106 can include identifiers of candidate models for selection by user. The prompting data sent at block 1106 can presented by sending webpages with embedded representations of candidate models. In one embodiment the embedded representations can include renderings of stored models stored in models area 2122 and selected to define candidate models for presentment to a user. In one embodiment, the identifiers can include image representations of the candidate models as provided by lightweight, e.g., .png images associated to a set of models defining the set of candidate models.

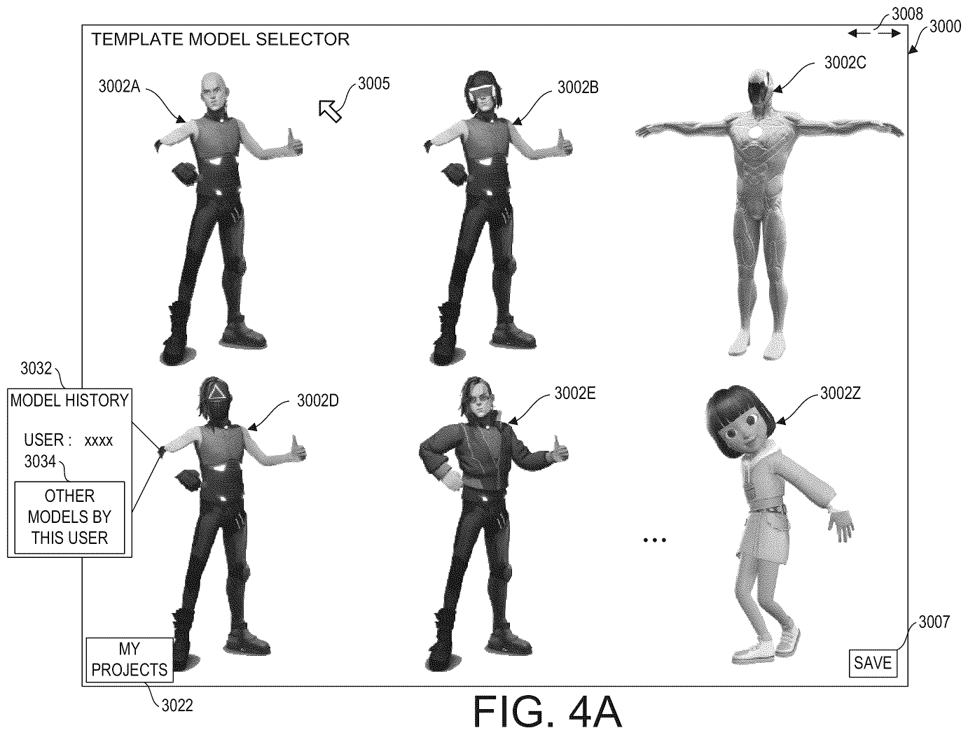

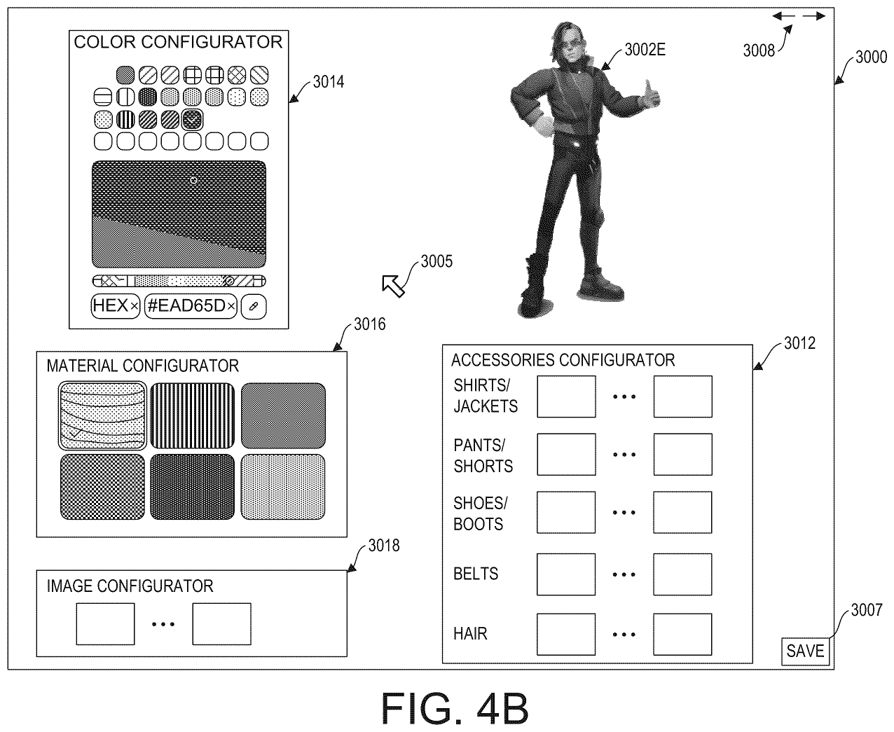

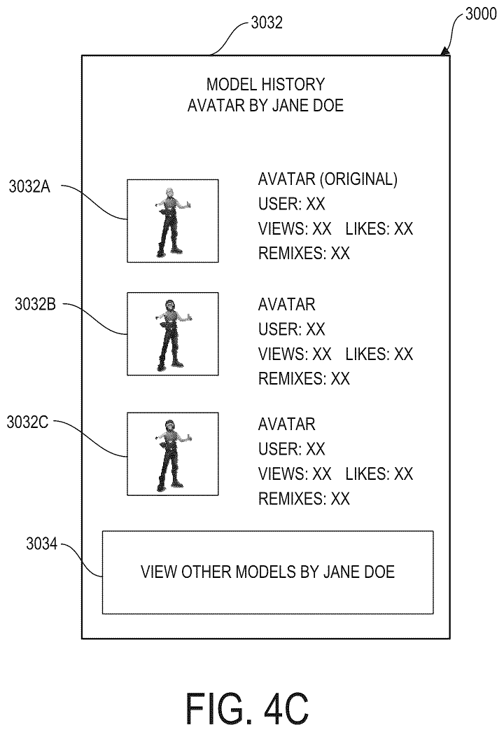

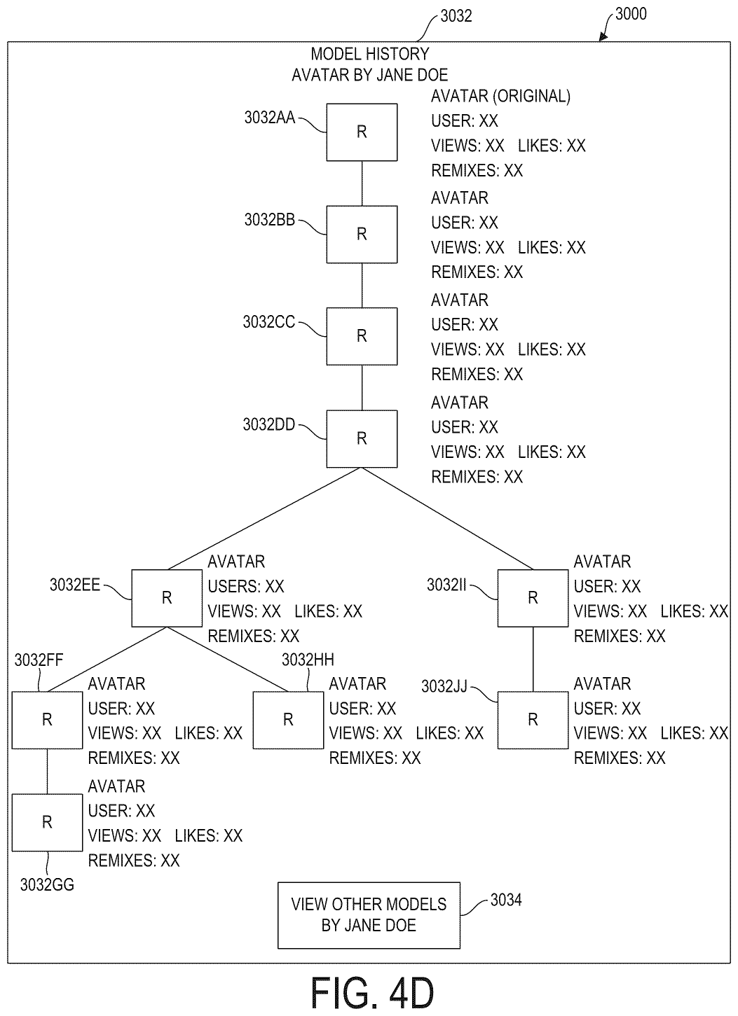

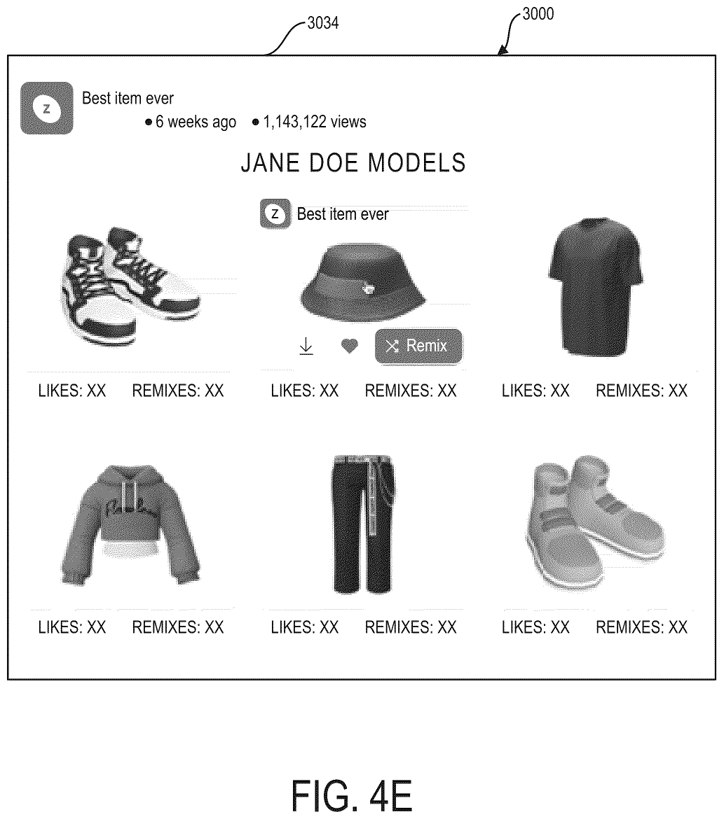

Prompting data on presentment on the current user's UE device 120A can define a user interface 3000 as indicated in FIG. 4A. User interface 3000 can present to the user a set of candidate models for selection as well as menu options for defining additional model configuration data. User interface 3000 in one embodiment can be a displayed user interface provided by one more user interface webpage. The candidate models for selection, as explained herein, can include stored models not associated to a user, and also user associated stored models. In the described example of FIG. 4A, there are shown model representations 3002A-3002Z indicating candidate models for selection. A user, e.g., with use of pointer 3005 (or a finger in the case of a touch based interface) can selected one of the models indicated by model representations 3002A-3002Z. On selection of one of the candidate models as a template model, the selected model becomes a base model for further customization. The indicated candidate models can include system models not associated to any user and also user-associated models. In the described example of FIG. 4A, model representations 3002A-3002C can indicate system candidate template models, and model representations 3002D-3002Z can represent user associated models associated to other users of system 100. In one aspect the user-associated models indicated by representations 3002A-3000C can be selected in dependence on a determination that a user associated to such models have user profiles exhibiting a threshold level of similarity with a user profile of a current user.

Referring to user interface 3000 as shown in FIG. 4B, user interface 3000 can also include various configurator controls. As shown in FIG. 4B, there can be presented to a user, e.g., an accessories configurator 3012, a color configurator 3014, a material configurator 3016, and an image configurator 3018. In one embodiment, user interface 3000 can be configured to transition from the screen display of FIG. 4A to the screen display of FIG. 4B in response to the user selection of a candidate model as a template model for customization. User interface 3000 can be configured so that a user can navigate between any screen displays of user interface 3000, e.g., with use of arrows 3008.

In one example, a user can select the model indicted by model representation 3002E as the template model serving as a base model for modification and customization (e.g., by clicking on or otherwise actuating model representation 3002E) and responsively, manager system 110 can serve the prompting data of FIG. 4B. The prompting data of FIG. 4B can facilitate modification and customization of the selected candidate model selected for further customization, i.e., the selected model associated to model representation 3002E. With use of the prompting data defined by accessories configurator 3012, the prompting data permits selection of accessories for modification of the selected template model used as a base model for a customized new model design. Within the cells of the depicted accessories configurator 3012, there can be displayed icons representing the indicated accessories, e.g., shirts, pants, shoes, belts, hair, etc. Additional accessories that can be presented as prompting data within accessories configurator 3012 can include, e.g., masks, bags, jewelry, and the like. The user may be give the option to specify the addition of an accessory by dragging and dropping a certain accessory within a cell of configurator 3012 onto an appropriate portion of the model representation 3002E. With use of the prompting data defined by color configurator 3014, the prompting data permits selection of color for modification of the selected base model. Manager system 110 can be configured so that the user has the option to specify the color of a portion, e.g., an accessory of a model by dragging and dropping a certain color from the color palette of configurator 3012 onto an appropriate portion of the model representation 3002E. With use of the prompting data defined by material configurator 3016, the prompting data of FIG. 4B permits selection of material for modification of the selected base model. Manager system 110 can be configured so that the user has the option to specify the material of a portion of a model by dragging and dropping a certain material from the material option cells of configurator 3016 onto an appropriate portion of the model representation 3002E. With use of the prompting data defined by images configurator 3018, the prompting data of FIG. 4B permits selection of images for modification of the selected base model. The images can include images of personal files of user uploaded into manager system 110 by a user. The images can include, e.g., photographic images, drawing images, or text based images. Manager system 110 can be configured so that the user has the option to specify, e.g., photographic data, indicia data, and/or text based data to a portion of a model by dragging and dropping a certain image from the image option cells of configurator 3018 onto an appropriate portion of the model representation 3002E. Selections made by user of color configurator 3014 and material configurator 3016 and image configurator 3018 can define selected textures of the user. In one example, the selection of a certain material can define the selection of a texture. In one example, the selection of a material can define the selection of a combination of textures. There is set forth herein in one embodiment, model configuration data received from the user that references at least one surface property customization of the user, and/or wherein the model configuration data received from the user references at least one accessory customization of the user. A surface property customization of a user, according to one embodiment, can be provided with use of, e.g., color configurator 3014, material configurator 3016, and/or image configurator 3018. An accessory customization of a user, according to one embodiment, can be provided with use of, e.g., accessory configurator 3012.

In one example, the menu options presented as prompting data within accessories configurator 3012, color configurator 3014, and/or material configurator 3016 of user interface 3000 as shown in FIG. 4B can be selected in dependence on a user profile of a user, which user profile can be dependent on preferences of the user.

At any point in the presentment of prompting data on user interface 3000 by manager system 110, the user can elect to specify that current model configuration data being developed by the user is finalized model configuration data defining a finalized model design. In one embodiment, the user can elect to actuate save button 3007 as shown in FIG. 4A and FIG. 4B. in order to save the currently defined model configuration data as finalized model configuration data. Prior to the entering an input into user interface 3000 to specify that a model being customized is a finalized design, e.g., by actuating “save” button 3007, the model being customized by a user can be regarded to be an in-draft model or model in-draft. Manager system 110, e.g., by the functioning of the described Threes.ds compliant web browser and API can be rendering within user interface 3000 in-draft models being customized and being developed. The rendering of the in-draft model can include 3D modelling rendering that permits 360 degree rotation of the in-draft model by the user.

In a further aspect, user interface 3000 can be configured to facilitate discovery by a current into the prior models designed by other users. Referring to FIG. 4B, model representations 3002D-3002Z presented as prompting data delivered to a current user indicate user-associated models designed by other users of system 100. Model representations 3002D-3002Z can be made active so that by appropriate actuation (a right click, tap, etc.) menu area 3032 is presented to user which can present as prompting data to user prompting data that specifies the user associated to the model representation that is actuated. Referring to FIG. 4A, a user can actuate model representation 3002D, and responsively area 3032 can be presented that specifies an identifier the user that created and designed the model associated to representation. By actuation of button 3034, a current user is able to view model representations of other models designed by the user associated to the actuated model representation 3002D.

Area 3032 according to one embodiment can be configured as shown in FIG. 4C. Referring to FIG. 4C manager system 110 can be configured so that by actuation of model representation 3002D, a user is able to review a history of revisions of the model represented by representation 3002D. The history of revisions can include a lineage of template models used in the development of the model represented by representation 3002D and can include backward history as well as forward history. In FIG. 4C the middle hierarchy displayed model representation 3032B can be a representation of the model represented by representation 3002D. The first upper representation 3032A can be an earlier versions of the model represented by representation 3002D, and the third lower model representation 3032C can represent a later version in a model versioning string. The first representation 3032A can be a representation of the original customized model in a string of customized models by the user associated to representation 3002D. Statistical data indicating the popularity of each model in the versioning string can be presented as prompting data to the user which can prompt the user to take action. Prompting data can include popularity statistics, e.g., a count of views, likes, and remixes associated to each version. A user can be prompted by prompting data indicating a popularity of one specific version to take action. The action can include selecting a model associated to one of the model representations 3032A-3032C of FIG. 4C as a template model to serve as base for development of a new model design. The model representations 3032A-3032C as shown in FIG. 4C can be active to permit the selection of the model associated to any one of the displayed model representations 3032A-3032C as a template model to serve as the base model for a new custom model design of the current user. The prompting data of FIG. 4C presents multiple selectable model representations 3032A-3032C in a hierarchical order, the multiple selectable model representations 3032A-3032C in the hierarchical order depicting a hierarchical relationship between at least one model and at least one template model associated to and used as a base to provide a customized model design defined by the a least one model, wherein the multiple selectable model representations in the hierarchical order are active to permit selection by the user of any one of the multiple selectable model representations to specify the template model for use in providing the custom model design of the user. In FIG. 4C model representation 3032B depicted in higher order hierarchical order relative to the model representation 3032C can represent the template model on which the custom design of the model represented by model representation 3032C can be based. In FIG. 4C model representation 3032A depicted in higher order hierarchical order relative to the model representation 3032B can represent the template model on which the custom design of the model represented by model representation 3032B can be based.

An alternative example of a model version history that can be presented in shown in FIG. 4D. In the use case depicted in FIG. 4D, model representation 3032EE can represent the model represented by representation 3002D of FIG. 4A. The prompting data of FIG. 4D presents multiple selectable model representations 3032AA-3032JJ in a hierarchical order, the multiple selectable model representations in the hierarchical order depicting a hierarchical relationship between at least one model and at least one template model associated to and used as a base to provide a customized model design defined by the a least one model, wherein the multiple selectable model representations in the hierarchical order are active to permit selection by the user of any one of the multiple selectable model representations to specify the template model for use in providing the current custom model design of the user currently being customized. In FIG. 4D model representation 3032DD depicted in higher order hierarchical order relative to the model representation 3032EE can represent the template model on which the custom design of the model represented by model representation 3032EE can be based. In FIG. 4D model representation 3032CC depicted in higher order hierarchical order relative to the model representation 3032DD can represent the template model on which the custom design of the model represented by model representation 3032DD can be based. Referring to FIG. 4C and FIG. 4D, the prompting data including representations of a hierarchy of models can specify users associated to the various models who custom created the various models. In one use case the different models depicted can have different respective users. In one embodiment, the user label associated to one or more model can specify “system model” to specify that the model is not associated to a user of system 100 and manager system 110 but rather is a system model. Referring to FIG. 4D it is seen that prompting data can include prompting data that presents a wide range of selectable models that may be similar to current model of interest, thus accelerating selection of a template model for a current custom design that is accurately aligned to information desired to be conveyed by a current user. In some use cases an original model of a hierarchical string of models can be provided by a system model. In one embodiment the user label associated to each model depicted can be active to that on actuation of the user label, other models of the user specified by the label can be displayed as prompting data as depicted in FIG. 4E.

Embodiments herein recognize that the presentment within prompting data of model representations depicting a history of model versions can facilitate accelerated flexible and comprehensive custom model development in a manner that avoids a need for users to expend extended training time learning intricacies associated to use of expert designer model development software packages. While user interface 3000 with the prompting data defined by accessories configurator 3012 of FIG. 3012 (FIG. 4B) can facilitate the addition of accessories to an in-draft model being customized, user interface 3000 can also facilitate the removal of accessories from an in-draft model. The removal of an accessory can result in a reduction of a size of an object shape represented by an in-draft model. It will be seen referring to FIGS. 4A-4D, that in order to remove an accessory from a current in-draft model, a user can merely call up prompting data configured according to the prompting data of FIG. 4C showing representations of a prior lineage of template models of the model currently being used a template model for an in-draft model design. The user can select one of the prior template models that is absent the unwanted accessory to establish the selected prior template model as the updated template model of the current in-draft custom model design of a current custom model design session. For example, if the user has specified the model of model representation 3032B (FIG. 4C) as the template model for custom model design, but wishes to remove the mask and hair, the user merely can call up the prompting data of FIG. 4C (e.g. by actuation of representation 3002D) and select instead the earlier template model of representation 3032A, which is absent of the mask and hair accessories, as the updated template model of an in-draft custom model of a current custom model development session.

By actuation of button 3034, manager system 110 can present the prompting data of FIG. 4E to a user. The prompting data of FIG. 4E presents model representations of other models designed by the user associated to model representation 3002D (FIG. 4A), or model representations of other models designed by the user associated to a model user label that can be actuated. Prompting data can include popularity statistics, e.g., a count of views, likes, and remixes associated to each model represented by the model representations of FIG. 4E. A user can be prompted by prompting data to take action. The action can include selecting a model associated to model representation of FIG. 4E as a template model to serve as base for development of a custom new model design. The model representations as shown in FIG. 4E can be active to permit the selection of the model associated to any one of the displayed model representations as a template model to serve as the base model for a new custom model design. As depicted in FIG. 4E, object representing models herein can represent any object, e.g., avatars, boots, hats, or any other item.

User interface 3000 can also include my projects button 3022. Manager system 110 can be configured so that on actuation of my projects button 3022 a current user is presented a menu of model options configured to the model menu options of FIG. 4A, 4C, 4D or 4E to facilitate selection by the user of template model that serves as a basis for a new customized model design. Manager system 110 can be configured so that on actuation of my projects button 3022 a user is presented with prompting data defined by a set of model representations of models stored in models area 2122 previously designed by the current user. The user can select from one of the representations to select a template model that serves as the base of a new model custom design of the current user.

On receipt of return data sent at block 1205, manager system 110 can proceed to block 1107. At block 1107, manager system 110 can determine whether model customization has been finalized by the current user. For example, at block 1107, manager system 110 can determine whether the user has actuated “save” button 3007 on user interface 3000 as shown in FIG. 4A or 4B to save the currently configured model configuration data. In the event that the current model configuration is not a finalized design, manager system 110 can return to a stage prior to generate block 1105 and can iteratively perform the loop of blocks 1105, 1106, and 1107 to iteratively generate and present prompting data until return data sent at block 1205 indicates, e.g., via a save control that the current model configuration is a finalized design.

Thus, in a second and subsequent iterations of generate block 1105, manager system 110 can iteratively generate and iteratively and dynamically generate new prompting data for presentment to the user. The new prompting data can be dependent, e.g., on the user's user profile as well as the prior selections of the user in the current custom model configuring session of the certain user (which itself can influence the user's user profile).

In determining at block 1107 that a finalized model design has been designated by a user, manager system 110 can proceed to block 1108. At block 1108, manager system 110 can ascertain whether the custom model configuration data defined by the user with return data sent at block 1205 defines a new model configuration. Referring to user interface 3000, embodiments herein recognize that in some use case scenarios, a user may define model configuration data that specifies a prior design. For example, in one use case scenario, the user can simply select a model from the candidate template model represented in the model selection area of FIG. 4A of user interface 3000 and then can actuate save button 3007 without adding any accessory customization or surface property customization, e.g., with use of a configurator as shown in 4B.

In such a situation, manager system 110 need not generate anew model. Rather, manager system 110 can simply copy a pre-existing model stored in models area 2122 and can assign that copy of the prior model to the new user to the current user or add a reference to the pre-existing model selected by the user that specifies ownership of the prior model by the current user. In the case manager system 110 determines at block 1108 that the custom model configuration data defined by the user specifies a pre-existing model stored in models area 2122, manager system 110 can proceed to store block 1109. At store block 1109, manager system 110 can copy a pre-existing model stored in models area 2122 and can assign that copy of the prior model to the new user to the current user or add a reference to the pre-existing model selected by the user that specifies ownership of the prior model by the current user.

Manager system 110 on completion of store block 1109 can proceed to block 1110. At block 1110, manager system 110 can send the model defined by the user defined model configuration data to the current user at UE device 120A. In the described example, the sending of the model at block 1110 can include, e.g., sending a link for access to the model via a messaging system. The model sent at block 1110 can be formatted for use in one or more enterprise model rendering system of enterprise model rendering systems 140A-140Z.

Accordingly, at block 1206, the user of UE device 120 can send the user's received model to the appropriate one or more enterprise model rendering system of enterprise model rendering systems 140A-140Z configured to render the model in the specified format. At block 1401, the one or more enterprise model rendering system of enterprise model rendering systems 140A-140Z can integrate the sent model on its respective model platform.

In common use cases, with return data sent at block 1205, a user can define model configuration data that defines a new model design that does not map to any pre-existing model stored in models area 2122. Examples of new model configurations can include, e.g., a previously unseen combination of an object shape representation with a new accessory, or a previously unseen combinations of object shape representations with a certain surface property. Examples of new model configurations can include model configuration data that specifies, e.g., a template model with a new accessory added, a template model with a new surface property (e.g., texture, including texture defining surface roughness, surface relief pattern, color, indicia pattern). A new model configuration herein can comprise any change to a model, e.g., texture, or accessory. For example, in the context of a polygon mesh model, a new model can comprise (1) old mesh+new textures. New textures can include new colors, and/or new images. New textures can be defined by specifying new materials (=normal maps, specularity, etc.), the addition of images on top of old textures, the addition of text on top of old textures. In one embodiment, a user can specify images (e.g., photographs, drawings, and/or text) to be applied as textures to define a customized model. In the context of a polygon mesh model a new model can comprise (2) old mesh+new accessories (defining a modification of the original mesh wherein the model is polygon mesh based). Accessories can include, e.g., adding a scarf to a coat model. Add a patch to a t-shirt model, add a belt to trousers model, and the like.

At block 1111, manager system 110 can generate one or more model according to the model configuration data defined by the user using user interface 3000. The generated one more model can be generated according to the custom model design defined by the model configuration data. Manager system 110 performing model generating at block 1111 can include manager system 110 performing microservices bus messaging as described herein.

At block 1112, manager system 110 can store into models area 2122 of data repository 108 one or more object representing model according to the custom model design of the user defined by the model configuration data received from the user responsively to the sending at block 1205. The storing into models area 2122 can include storing at least one model of the generated one or more model generated at block 1117. With the storing of one or more object representing model according to the custom design of the user at block 1205, manager system 110 can store into models area 2122 of data repository 108 model configuration data sent by the user at block 1205 as metadata associated to the stored one or more model. The model configuration data can define various tags such as, e.g., a user tag specifying the user of the stored one or more model, and a template model tag specifying a template model associated to the stored one or more model upon which the custom design of the one or more model is based. The storing of model configuration data as metadata associated with one or mode stored model can facilitate the generation and presentment of active promoting data, e.g., as shown in FIG. 4A-4E in which active selectable model representations of models are presented for user selection so that a user can select a template model to be used as a base for a current custom model development session. In some embodiments, as explained with FIG. 4A-4E, a hierarchical ordering of models can be presented with prompting data in which representations of customized models are presented in lower order hierarchy relative to their respective template models, and in which respective models are depicted with associated user labels. For such functionality, which permits rapid development of new custom models, metadata can be stored with stored object representing models, which metadata can specify such items as template model and user.

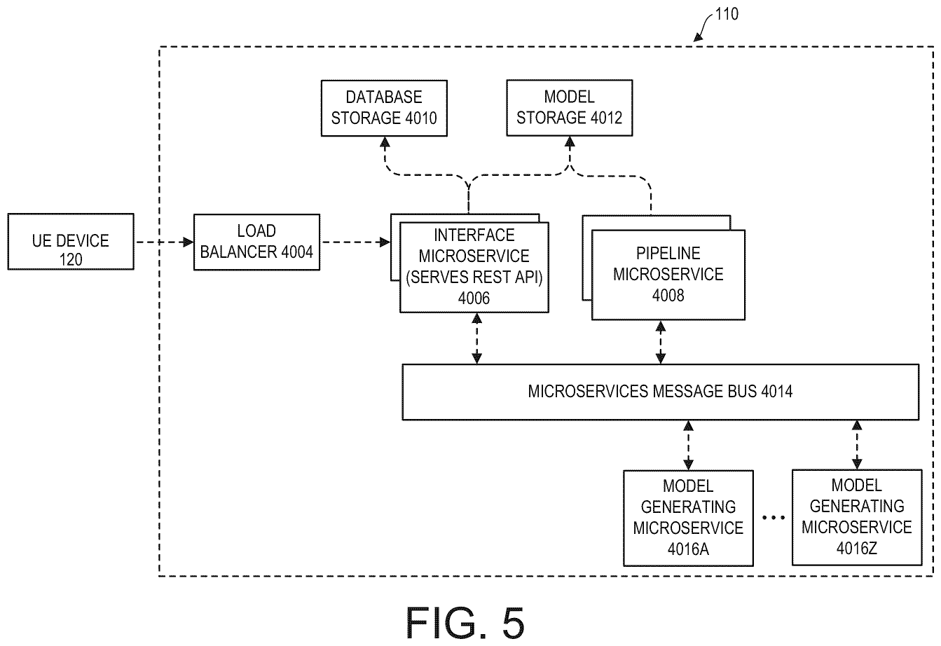

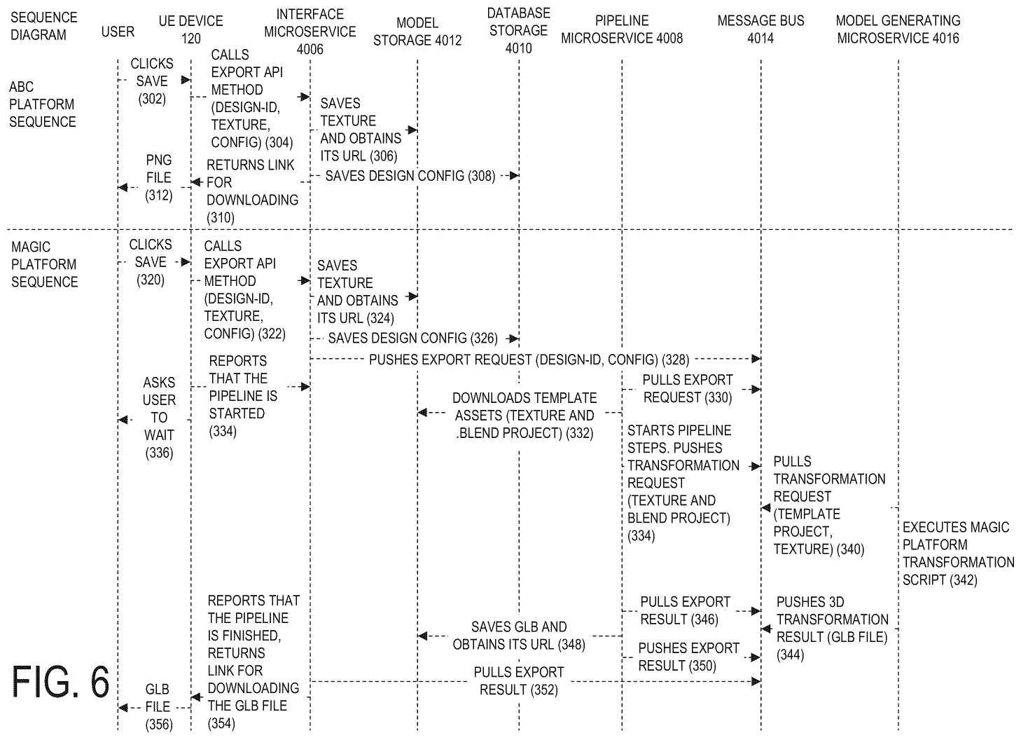

Further aspects of manager system 110 are described with reference to FIGS. 5 and 6. FIG. 5 depicts a microservices architecture for manager system 110 according to one embodiment. FIG. 6 is a flowchart illustrating a method for performance by manager system 110 including interoperation between microservices of manager system 110 according to one example.

Referring to FIG. 5, manager system 110 can employ a microservices architecture featuring a variety of microservices. In one example, manager system 110 can include an interface microservice 4006, a pipeline microservice 4008, and a plurality of differentiated model generating microservices 4016A-4016Z. The highlighted microservices can interoperate with microservices system bus 4014.

Interface microservice 4006 can be responsible, e.g., for running prompting process 113 to send prompting data to user and can also be responsible for responding to return data returned from a user in response to prompting data. Interface microservice 4006 can further be responsible for sending models including newly generated models to users in dependence on model configuration data defined by user in response to prompting data.

Interface microservice 4006 can, e.g., interrogate microservices message bus 4014 for new models generated by model generating microservices 4016A-4016Z. On the identification of a model sent to microservices message bus 4014, interface microservice 4006 can capture the model, e.g., expressed in a link, and transmit the same to appropriate users of UE devices 120A-120Z.

Pipeline microservice 4008 can organize model generation requests for sending to microservices message bus 4014. Pipeline microservice 4008 can manage the delivery of messages defining requests for model generation to microservices message bus 4014. In one aspect, pipeline microservice 4008 can organize messages defining model generation requests into a queue so that earlier sent messages can be served in priority order relative to later delivered messages. Pipeline microservice 4008 can examine model configuration data defined by user sent to manager system 110 at block 1205 FIG. 2. On receipt of model configuration data from a user, interface microservice 4006 can deliver the configuration data to pipeline microservice 4008.

The configuration data can reference various model assets, e.g., object shape representing model data in combination with surface properties data selected by user. These assets can map to file data stored in model storage 4012. Pipeline microservice 4008 can retrieve model asset data from model storage 4012. With a model generation request message sent to microservices message bus 4014, pipeline microservice 4008 can include such model asset data. In one example herein, model configuration data of a user can include, e.g., (i) a model identifier, i.e., design-ID, specifying the model, (ii) a user identifier; (iii) surface properties parameter values; (d) accessories parameter values and (iv) template model modification data which references a selected template model and modification stages for modification of the template model, as well as (v) identifiers for one or more target model rendering system. The item (v) can be provided in one example by an identifier of a required file format of the target model rendering system.

Respective ones of model generating microservices 4016A-4016Z can perform a variety of processes including (a) obtaining parameter values specifying any accessories and/or surface properties defined by a user in the model configuration data; (b) obtaining file data defining a template model specified by user in user defined configuration data; (c) running script or alternative 3D modeling software to modify 3D object shape representing data in accordance with the accessory specified in the configuration data (e.g., in the case of a polygon mesh, modifying the polygon mesh of the template model); (d) running script of alternative 3D modeling software to remove and replace surface properties of the template model as modified by any 3D shape modification (if any), (e) formatting the resulting transformed and generated model data into the format specified by a target model rendering system, and (f) exporting the formatted generated model for storage into storage (and re-use as a future template model) and for sending to the user.

In further aspects, manager system 110 as shown in FIG. 5 can include database storage 4010 for storing user data, such as user data described with reference to users area 2121 shown in FIG. 1 as well as model data and model storage 4012 for storing model data, such as model data described with reference to models area 2122 of data repository of FIG. 1, as well as user data. Database storage 4010 and model storage define an example of data repository 108 of manager system 110. Users area 2121 can be partially defined by database storage 4010 and model storage 4012. Models area 2122 can be partially defined by database storage 4010 and model storage 4012.

To facilitate scaling, request data defined by users of UE devices 120A-120Z can be sent to load balancer 4004, which can balance request data between a plurality of instances of interface microservice 4006. Model generating microservices 4016A-4016Z can be configured to transform pre-existing 3D model and corresponding surface properties such as textures into different formats required by consuming platforms such as the exemplary fictitious platforms herein, e.g., ABC platform XYZ platform, and MAGIC platform.

Further aspects of the described microservices described with reference to FIG. 5 are set forth with further reference to the flowchart of FIG. 6.

Blocks 302 to 310 illustrate manager system 110 receiving model configuration data defining a two-dimensional model. A two-dimensional object representing model might be rendered by the fictitious enterprise model rendering system ABC platform.

At block 302, after performing a number of manipulations with a selected template model, the user can actuate “Save”, e.g., using save button 3007 of user interface 3000 to designate a finalized model design. At block 302, a user can actuate “save” to designate finalization of model configuration data after engaging in a user interactive session in which the user is presented with one or more iteration of prompting data presented on user interface 3000.

At block 304, a UE device of the current user can send an export request containing model configuration data which can include, e.g., design-ID providing an identifier for the new design, texture parameter values (TEXTURE in FIG. 6) and template model modification data (CONFIG in FIG. 6). At block 304 interface microservice 4006, can call an export API method to export model configuration data defined by a user. Texture data can be provided by a base64 image obtained after overlaying custom images and changing colors. The template model modification data (CONFIG) can contain user-defined model configuration data, a structure that presents information about which configuration steps have been applied to the model during remix e.g., updating area colors, adding overlaying images. Model configuration data in the example described can include a template model identifier, specifying a template model selected by the user and surface properties data. The surface properties data can comprise texture data. Texture data herein can define, e.g., surface roughness, surface relief pattern, color, indicia pattern, and the like.

At block 306, interface microservice 4006 can save the texture data to model storage 4012 and can receive the URL under which the texture was stored. At block 306, interface microservice 4006 can save a “texture” defined by the user and store user defined texture to model storage 4012 and can received a URL for the stored texture data. At block, 308 interface microservice 4006 can store the template model modification data to model storage 4012 and database storage 4010 and can receive the URL under which the texture was stored. At block 308, interface microservice 4006 can save the template model modification data to database storage 4010. At block 308, interface microservice 4006 can save the template model modification data to the model storage 4012 so that it is now recorded what modifications the original model has undergone.

At block 310, interface microservice 4006 can return a link for downloading the resulting texture data from the model storage 4012. At block 310, interface microservice 4006 can return a link to model associated to the user defined model configuration data and at block 312 the user can access the link to access a .png file. The .png file can encode and format the custom model configured by user. At block 310 interface microservice 4006 can return a link for downloading the resulting texture into model storage 4012. At block 312, the UE device of the current user based on prompting data sent by manager system 110 can prompt the user to download the texture defining a new model so it can be imported to an appropriate target model rendering system of enterprise model rendering systems 140A-140Z for customizing a user avatar. In the described example of a 2D model, a new model can be defined by an applied texture to a template model provided by a two dimensional model. At block 312, prompting data can be sent to a user to prompt the user to download the texture so it can imported to a target enterprise model rendering system.

With further reference to the flowchart of FIG. 6, blocks 320-356 specify an example in which the user defines model configuration data according to a custom model design that specifies a three-dimensional model not previously existing or stored in models area 2122 and in response to the user defined model configuration data, microservices interoperate and a model generating microservice generates a model.

At block 320, after performing a number of manipulations with a selected template model, the user can actuate save button 3007 of user interface 3000 to designate finalization of a new model design.

At block 322, the UE device can send an export request containing model configuration data to manager system 110. The model configuration data can include, e.g., a design-ID, texture data and template model modification data (referred to as CONFIG) in FIG. 6, as well as target rendering system data specifying one or more target rendering system. The texture in one example can be provided by a base64 image obtained after overlaying custom images and changing colors. The model configuration data in one embodiment can reference one or more accessory added by a user to a template model. The template model modification data (CONFIG) can be provided by a data structure that presents information about which configuration steps have been specified for application to a selected template model during remix e.g., defining texture customization e.g., by updating area colors, adding overlaying images and/or defining accessory customization.

At block 324, interface microservice 4006 can save the texture data to model storage 4012 and can receive a URL under which the texture data was stored. At block 326, interface microservice 4006 can save the template model modification data to the model storage 4012 and to database storage 4010 so that it is now recorded what modifications the original user selected template model have been specified.

At block 328, interface microservice 4006 can push an export request to microservices message bus 4014. The export request can contain data of the user-defined model configuration data, including, e.g., the design-ID, template model modification data, and target rendering system data. Once interface microservice 4006 pushes the export request at block 328 to the microservices message bus 4014, interface microservice 4006 can respond to confirm that the export API request is executed successfully, and the model generation pipeline has been started. Interface microservice 4006 can send appropriate prompting data to a user an at block 336 the current user's UE device prompts the user to wait until the model is exported.

At block 330, pipeline microservice 4008 can pull the model data export request from microservices message bus 4014 and at block 332 pipeline microservice 4008, given model configuration data including design-ID and the template model modification data, can download the corresponding model asset data exported at block 332, e.g., including template model project and all resources needed for generating the new model.

At block 334, in response to the received model asset data downloaded at block 332 and in response to the model configuration data exported by a user at block 322, pipeline microservice 4008 can send model generating request data to microservices message bus 4014. The model generating request data can include one or more classification tag to invoke action of one or more model generating microservices 4016A-4016Z based on target rendering system data of the received model configuration data.

At block 340, one or more model generating microservice of model generating microservices 4016A-4016Z subscribing to the one or more classification tag can pull the model generation request from the message bus.

At block 342, given the model asset and the user-defined model configuration data, the one or more model generating microservice of microservices 4016A-4016Z can execute a flow of typical model generation actions which can include, e.g., (a) obtaining parameter values specifying any accessories and/or surface properties defined by a user in the model configuration data; (b) obtaining file data defining a template model specified by user in user defined configuration data; (c) running script or alternative 3D modeling software to modify 3D object shape representing data in accordance with the accessory specified in the configuration data (e.g., in the case of a polygon mesh, modifying the polygon mesh of the template model; (d) running script of alternative 3D modeling software to remove and replace surface properties of the template model as modified by any 3D shape modification (if any), (e) formatting the resulting transformed and generated model data into the format specified by a target model rendering system, and (f) exporting the formatted generated model for storage into storage (and re-use as a future template mode) and for sending to the user.

The flow can produce one or more newly generated model represented, e.g., as a .glb file, and/or another file format as called for by the particular one or more target enterprise model rendering system of enterprise model rendering systems 140A-140Z. Model file formats, can include, e.g., .glb, .lensproj, .fbx, .arproj, among others.

At block 344, given the .glb file (or other/additional filed formats associated respectively to the one or more target rendering systems of enterprise model rendering systems 140A-140Z), the one or more invoked model generating microservice of model generating microservices 4016A-4016Z can push a model generation result message to microservices message bus 4014.

At block 346, pipeline microservice 4008 can pull the model generation result message from microservices message bus 4014. At block 348, pipeline microservice 4008 can store the one or more output model file (e.g., in .glb) to model storage 4012 and can receive the URL under which the file was stored. At block 348, pipeline microservice 4008 can store the output model file in one or more file format. In one example, if more than one model is generated according to one or more model file formats, the multiple file formats can be stored. In one example, where the target rendering system requires proprietary rendering system specific format, pipeline microservice 4008 can store the one or more model in the rendering system specific format and in an interoperable format so that subsequent prompting data can reference the model in the interoperable file format. The stored one or more model file (e.g., in .glb format) can then be presented by manager system 110 as a candidate template model which can be identified and referenced with prompting data presented to a second user and any other subsequent user of system 100.

At block 350, pipeline microservice 4008 can push the export result message, e.g., with the one or more model file URL to microservices message bus 4014. At block 352, interface microservice 4006 can pull the export result message from microservices message bus 4014. At block 354, interface microservice 4006 can report that the one or more model generation pipeline is finished and can pass to the users UE device the link for downloading the model file (e.g., in .glb format). At block 356, the UE device can prompt the user to download the one or more model file so that they can be imported to one or more target enterprise model rendering system of enterprise model rendering systems 140A-140Z. Further explanation of processing stages set forth in reference to the flowchart of FIG. 6 is provided with reference to Table C.

TABLE C

| | |
|---|---|
| Step number | Stage explanation |

ABC Platform Sequence

| | |
|---|---|
| 302 | After doing a number of manipulations with the model, the user actuates Save. |
| 304 | UE device sends an export request containing design-ID, texture and CONFIG |
| | (template model modification data). Texture can be provided by a base64 image |
| | obtained after overlaying custom images and changing colors. The template model |
| | modification data contains a structure that presents information about which |
| | configuration steps have been specified for application to the model during remix |
| | e.g., updating area colors, adding overlaying images. |
| 306 | Interface microservice saves the texture to the model storage and receives the URL |
| | under which the texture was stored. |
| 308 | Interface microservice saves the template model modification data to the model |
| | storage so that it is now recorded what modifications have been specified for |
| | application to the original template model. |
| 310 | Interface microservice returns a link for downloading the resulting texture from the |
| | model storage. |
| 312 | UE device prompts the user to download the texture defining a customized model |
| | so it can be imported to a target model rendering system. |

Magic Platform Sequence

| | |
|---|---|
| 320 | After doing a number of manipulations with the model, the user actuates Save. |
| 322 | UE device sends an Export request containing design-ID, texture and CONFIG |
| | (template model modification data). Texture is a base64 image obtained after |
| | overlaying custom images and changing colors. The template model modification |
| | data contains a structure that presents information about which configuration steps |
| | are specified for application to the model during remix, e.g., updating area colors, |
| | adding overlaying images and accessories. |
| 324 | Interface microservice saves the texture to the model storage and receives the URL |
| | under which the texture was stored. |
| 326 | Interface microservice saves the design config template model modification data to |
| | the model storage so that it is now recorded what modifications have specified for |
| | the original template model. |
| 328 | Interface microservice pushes an export request to the microservices message bus. |
| | The request contains user-defined model configuration data. The interface |
| | microservice cand send a notification to the user indicating that export request has |
| | been sent. |
| 330 | Pipeline microservice pulls the export request from the message bus. |
| 332 | Given the model configuration data including design-ID, pipeline microservice |
| | downloads the corresponding template model project and all resources needed for |
| | generating the new model. |
| 334 | Pipeline microservice publishes a classification tagged model generating request to |
| | the microservices system bus |
| 336 | UE device prompts the user to wait until the model is exported |
| 340 | Model generating microservice pulls the model generation request from the |
| | message bus. |
| 342 | Given the template project and the user-defined model configuration data, model |
| | generating microservice executes a flow of actions for model generation. The flow |
| | can produce a newly generated model represented as a .glb file (in case of a certain |
| | enterprise model rendering system requiring a .glb model format). |
| 344 | Given the .glb file, the model generating microservice pushes a model generation |
| | result message to the message bus. |
| 346 | Pipeline microservice pulls the model generation result message from the message |
| | bus. |
| 348 | Pipeline microservice saves the .glb file to model storage and receives the URL |
| | under which the file was stored. |
| 350 | Given the .glb file URL, pipeline microservice pushes the export result message to |
| | the microservices message bus. |
| 352 | Interface microservice pulls the export result message from the message bus. |
| 354 | Interface microservice reports that the model generation pipeline is finished and |
| | passes UE device the link for downloading the .glb file. |
| 356 | UE device prompts the user to download the .glb file so it can be imported to the |
| | target enterprise model rendering system. |

Referring again to model generating microservices 4016A-4016Z, operations between the different microservices can be differentiated in dependence on formatting requirements of the various model generating microservices. Inputs, and outputs of various microservices of a set of model generating microservices 4016A-4016Z, in one example are set forth in reference to Table D below.

TABLE D

| | | | | User | | |
|---|---|---|---|---|---|---|
| | Platform | | Template | generated | | |
| Microservice | supported | Environment | assets | input | Process | Output assets |
| 4016A | Decentraland ® | Linux, | 3D model | A texture | Using | .glb file of |
| | | Blender ®, | represented | colored by | Blender ® | a colored |
| | | Python, BPY | as a .blender | the user, | automation | model |
| | | | project | parameters | scripts replace | |
| | | | | of the | the default | |
| | | | | selected | grey texture | |
| | | | | accessory | with the given | |
| | | | | (optional) | one and save | |
| | | | | | the model | |
| | | | | | as .glb file | |
| 4016B | SnapChat ® | Linux | Linux Temp | A texture | Only the | Zipped Lens |
| | | | late assets: | colored by | functionality | Studio ® |
| | | | 3D model | the user, | of the file | project with |
| | | | represented | parameters | system under | the colored |
| | | | as a Lens | of the | Linux is used. | model |
| | | | Studio | selected | The textures | |
| | | | project | accessory | in the Lens | |
| | | | | (optional) | Studio ® | |
| | | | | | project | |
| | | | | | package are | |
| | | | | | swapped, and | |
| | | | | | the unused | |
| | | | | | accessory | |
| | | | | | files | |
| | | | | | (additional | |
| | | | | | models) in the | |
| | | | | | same project | |
| | | | | | are deleted, | |
| | | | | | leaving only | |
| | | | | | the user- | |
| | | | | | selected | |
| 4016C | Instagram ® | MacOS/ | 3D model | A texture | Replace the | Zipped |
| | | Windows, | represented | colored by | default grey | SparkAR ® |
| | | SparkAR ® | as a | the user | texture with | project with |
| | | | SparkAR ® | | the given one | the colored |
| | | | project | | using only | model |
| | | | | | filesystem and | |
| | | | | | archive | |
| | | | | | SparkAR ® | |
| | | | | | project | |
| 4016D | Shopify | Linux, | 3D model | A texture | Using | .glb file of |
| | | Blender ®, | represented | colored by | Blender ® | a colored |
| | | Python, BPY, | as a .blender | the user | automation | model |
| | | Script [symbol] | project | | scripts replace | |
| | | | | | the default | |
| | | | | | grey texture | |
| | | | | | with the given | |
| | | | | | one and save | |
| | | | | | the model | |
| | | | | | as .glb file | |
| 4016E | Zepeto ® | Environment: | 3D model | A texture | Using | “.zepeto” file |
| | | Linux, Unity | represented | colored by | Blender ® | exported |
| | | | as a .blender | the user, | automation | from Unity |
| | | | project | parameters | scripts replace | |
| | | | | of the | the default | |
| | | | | selected | grey texture | |
| | | | | accessory | with the given | |
| | | | | (optional) | one and save | |
| | | | | | the model as | |
| | | | | | an .fbx file. | |
| | | | | | After sending | |
| | | | | | this file to | |
| | | | | | Unity and | |
| | | | | | running the | |
| | | | | | scripts to | |
| | | | | | export the | |
| | | | | | model in | |
| | | | | | zepeto format | |
| 4016F | Roblox ® | Linux | none | A texture | None | Texture to |
| | | | | colored by | | use in |
| | | | | the user | | Roblox ® |
| | | | | | | game |

References is now made again to the flowchart of FIG. 2. At send block 1207, a user can enter an input control to user interface 3000 to send received model sent at block 1113 to a selected one of enterprise model rendering systems 140A-140Z (in the example described, enterprise model rendering system 140A can represent the fictitious platform MAGIC platform. In response to receipt of the user sent model, the selected enterprise model rendering system of enterprise model rendering systems 140A-140Z can integrate the sent model at integrate block 1402. At return block 1114, manager system 110 can return to stage prior to block 1101 to iteratively receive new registration data from new users or updated registration data from existing registered users and can iteratively perform the loop of blocks 1101-1114 for a deployment period of manager system 110. At return block 1208 UE devices 120A-120Z can return to a stage preceding block 1201 so that UE devices 120A-120Z can be iteratively performing the loop of blocks 1201-1207 to iteratively send new registration data by new users or updated registration data by existing users. Enterprise model rendering systems 140A-140Z at block 1403 can return to a stage prior to a block 1401 so that enterprise model rendering systems 140A-140Z can iteratively perform the loop of blocks 1401 to 1403.

Embodiments herein recognize, with reference to the loop of blocks 1101-1114, that a stored model according to a custom design of a current user (first iteration) can be evaluated for inclusion in a set of selectable candidate models presented in prompting data presented to a second user (subsequent iteration), wherein the second user can select the stored model as a template model to be used as base for custom model design of the second user. There is set forth herein according to one embodiment generating, by a system, prompting data for prompting a user of the system to define configuration data that specifies a model configuration, wherein the prompting data references a set of candidate models that are selectable by the user; presenting the prompting data to the user, wherein the prompting data references the set of candidate models that are selectable by the user; receiving model configuration data from the user subsequent to the presenting the prompting data, wherein the model configuration data received from the user specifies a custom model design of the user and references a previously stored model, which previously stored model, in response to data of the prompting data, has been selected as a template model for use in providing the custom model design of the user; generating an object representing model using data of the model configuration data received from the user; and sending the generated object representing model to the user, wherein the method includes storing a certain model according to the custom model design into a data repository; evaluating the certain model for inclusion in a candidate set of candidate models for presentment to a second user of the system; and presenting subsequent prompting data to the second user in response to a determination from the evaluating that a criterion has been satisfied, wherein the subsequent prompting data presented to the second user references the certain model.

In one use case, finalization of model configuration data by a user at block 1205 can invoke the generation of a single model according to one format associated to one enterprise model rendering system of enterprise model rendering systems 140A-140Z. In another use case, finalization of model configuration data by a user at block 1205 can invoke the generation of multiple models of multiple formats, wherein respective ones of the multiple formats are associated to respectively different ones of enterprise model rendering systems 140A-140Z.

According to one aspect, for supporting the generation of multiple custom models in response to finalization of model configuration data by a user, models that are subject to selection as a template model by a user can be stored in an interoperable model file format that readily accommodates transformation into propriety model file formats as may be required by select ones of enterprise model rendering system 140A-140Z. One example of an interoperable file format is the .glb file format which is the binary version of the Graphics language Transmission Format (gITF™), which is a standardized file format for 3D scenes and models developed by the Khronos group.

According to one method, manager system 110 can be configured so that model representations of model representations 3002A-3002Z can map to respective models stored in model storage 4012 that are stored in an interoperable model file format that can be subject to being reformatted into multiple different formats. Embodiments herein recognize, for example, that the .glb model format can be subject to be reformatted into any one of a number of formats as may be associated to various ones of enterprise model rendering systems 140A-140Z, e.g., e.g., .arproj, .lensproj and tbx.

According to one embodiment, manager system 110 can be configured so that models associated to model representations 3002A-3002Z of user interface 3000 as shown in FIG. 4A are stored within model storage 4012 in a selected interoperable model file format, e.g., the .glb file format, or another interoperable model file format that is subject to being reformatted into another format associated to one or more of enterprise model rendering systems 140A-140Z. In one example, for the providing of representations 3002A-3002Z rendered as part of user interface 3000, manager system 110 can be configured render 3D models stored in model storage 4012 in the selected interoperable model file format, e.g., .glb.

Embodiments herein recognize that different ones of enterprise model rendering system 140A-140Z can have different and changing data size limits for models that they can render. For example, enterprise model rendering system 140J in one embodiment can have a size limit of 3.0 mb for models rendered thereon, enterprise model rendering system 140K can have a size limit of 5.0 mb for models rendered thereon, and enterprise model rendering system 140L can have a size limit of 3.5 mb for models rendered thereon. In another aspect, embodiments herein recognize that different ones of enterprise model rendering system 140A-140Z can have different and changing bone structure requirement for models that they render, and different and changing requirements for the models that they render in terms of, e.g., numbers of polygons, numbers of triangles, and numbers of vertices.

In one aspect, for providing a model to be rendered on multiple enterprise model rendering systems 140A-140Z, manager system 110 by revisioning process 116 can be configured to crawl specification data for enterprise model rendering system 140A-140Z to determine data size limits for models associated to each of the enterprise model rendering systems of enterprise model rendering systems 140A-140Z on which the interoperable model is to be rendered subsequent to transformation. Manager system 110 by revisioning process 116 can be configured to crawl specification data for enterprise model rendering system 140A-140Z to determine different bone structure requirement for models rendered on the respective enterprise model rendering systems 140A-140Z, and different requirements for models rendered on different respective enterprise model rendering systems 140A-140Z, e.g., numbers of polygons, numbers of triangles, and numbers of vertices. Manager system 110 by revisioning process 116 can then update one or more model generating microservice that generates interoperable models to establish the size of the model formatted in the interoperable file format (the interoperable model) to conform to the limit of the smallest model size limit for the enterprise model rendering systems of enterprise model rendering systems 140A-140Z on which the model is to be rendered. Manager system 110 by revisioning process 116 can also update the one or more model generating microservice that generates interoperable models to establish numbers of polygons, numbers of triangles, and numbers of vertices of the model formatted in the interoperable file format (the interoperable model) to simultaneously conform to the requirements of selected multiple ones of enterprise model rendering systems 140A-140Z on which the interoperable model is to be rendered after transformation. Manager system 110 by revisioning process 116 can also update the one or more model generating microservice that generates interoperable models to establish bone structure requirements to simultaneously conform to the requirements of selected multiple ones of enterprise model rendering systems 140A-140Z on which the interoperable model is to be rendered after transformation.

Manager system 110 for providing the output of multiple models for being rendered on multiple different enterprise systems can be configured so that model configuration data established by a user includes enhanced model configuration data as set forth in Table E.

TABLE E

| | | | | User | | |
|---|---|---|---|---|---|---|
| | | | User | defined | | |
| | | | defined | surface | Template | |
| | | | accessory | property | model | Enterprise model |
| | Model ID | | parameter | parameter | modification | rendering system |
| Row | (Design-ID) | User ID | values | values | data | (output format) |
| 1 | M001 | U004 | XX | XX | XX | ID-140J; |
| | | | | | | ID-140K; |
| | | | | | | ID-140L; |
| | | | | | | ID- |
| | | | | | | FLAG_MM037 |
| 2 | M002 | U016 | XX | XX | XX | ID-140J |
| 3 | M003 | U019 | XX | XX | XX | ID-140L |

Referring to Row 1, User U004 can define with use of user interface 3000 model configuration data that defines, e.g., a new model ID assigned by manager system 110, the user's ID, a template model ID specifying the template model selected by a user, user selected accessories parameter values and surface property parameter values, as well as an identifier of the target enterprise model rendering system of enterprise model rendering systems 140A-140Z. Referring to Row 1 the configuration data for user U004 can includer identifier data specifying first, second and third target model rendering systems 140J, 140L, 140L for rendering of different models based on the defined configuration data of the user. Referring to Row 2 and Row 3, the configuration data for users U016 and U019 can specify only a single enterprise model rendering system.

Where a model associated to a model representation 3002A-3000Z as shown in FIG. 4A is a model formatted in an interoperable model format for accommodating transformation into different formats for rendering on a plurality of enterprise model rendering systems 140A-140Z, user interface 3000 can provide prompting data that prompts a user to make a selection as to one or more of the available rendering systems which the newly configured in-draft model being customized by the user can be rendered on. For example, user interface 3000 can be configured so that prior to actuation of save button 3007, prompting data menu options are presented to a user prompting a user to select one or multiple enterprise model rendering systems for output of a model in accordance with the model configuration data of the user. Further, model representations of model representations 3002A-3002Z as shown in FIG. 4A can be configured so that when a user clicks on or otherwise actuates the model representation prompting data appears, e.g., as an overlay on the representation indicating the multiple formats associated to multiple enterprise model rendering systems which are available for output of the new model being configured by the user. The user can then select from the menu options to designate the targeted enterprise model rendering systems of enterprise model renderings systems 140A-140Z.

Providing the described multi-model functionality can include the following: (a) A model can be formatted in an interoperable model format, e.g., .glb, and the model formatted in an interoperable model format (the interoperable model) can be stored in model storage 4012 (FIG. 4A) with the model having a file size that simultaneously complies with the file size requirements of multiple enabled enterprise model rendering system according to the smallest size limit of the enabled target enterprise model rendering systems that are enabled, and/or the model can be configured to simultaneously comply with other sets of model requirements across enterprise model rendering systems, e.g., in relation to numbers of polygons, numbers of triangles, numbers of vertices, and bone structure (b) a user interface 3000 can be presented to the user with prompting data (in the form of a representation of the model) prompting selection of the interoperable model, with additional prompting data specifying available target model rendering systems for a new custom model based on the interoperable model used as a template model; (c) a user can select the interoperable model as a template model, can specify multiple target enterprise model rendering system and can customize the model, e.g., by specifying accessories and/or surface properties; (d) upon finalization of a new custom model design, a user presses “save” button 3007 (FIG. 4A or 4B) to generate configuration data as described in Row 1 of Table E, e.g., which specifies multiple target enterprise model rendering systems based on the user's selection of target model rendering systems; (e) in response to generation of configuration data by the user, manager system 110 uses the configuration data defined by the user to output the user's newly configured model into N different formats associated to N different enterprise model rendering systems of enterprise model rendering systems 140A-140Z.

The multiple different formats can include, e.g., .arproj, .lensproj and .fbx for first, second, and third enterprise model rendering systems. For generating multiple models, the following can occur: (i) in response to the configuration data, as set forth in reference to FIG. 4B pipeline microservice 4008 at block 330 can push a model generation request (transformation request) to microservices message bus 4014 with a classification tags specifying action by N model generating microservices 4016K-4016L that are associated to enterprise model rendering systems 140K-140L in the example described with reference to Table E. For tagging model generating request with appropriate classification tags to invoke the appropriate model generating microservices 4016J-4016L, pipeline microservice 4008 can examine model configuration data that specifies the target enterprise model rendering systems 140K-140L. In one example, where the target enterprise model rendering system requires a rendering system specific format other than an interoperable model file format, pipeline microservice 4008 can save the one or more model in the rendering system specific format and in the interoperable model format, so that subsequent prompting data can reference the interoperable model, configured to accommodate customization and formatting into multiple different model file format.

For such functionality in one embodiment, respective model generating microservices 4016J-4016L associated to the selected enterprise model rendering systems 140J-140L can be configured to generate based on finalized custom model configuration data defined by a user, a first model formatted according to first (e.g. proprietary) model format of a target enterprise model system and a second model in an interoperable model format, e.g., in .glb, each of which can be stored in model storage 4012. The model in the interoperable format can be selected by manager system 110 for presentment in prompting data to a second user as a candidate model for selection by the second user of a template model to design a new custom model by the second user which can be output in multiple model formats.

For such functionality in another embodiment, the model configuration data as described in Table E, as shown in Row 1 can include a special flag ID-FLAG_MM037, that can be examined on receipt by manager system 110 to responsively publish a model generating request to microservices message bus 4014 with a classification tag to invoke the operation of a certain one of model generating microservices 4016A-4016Z, e.g., model generating microservice 4016I, that generates interoperable models, while additional model generating microservices associated to the metadata ID-140J, ID-140K, and ID-140L of Row 1 are also invoked. The special flag including the string FLAG can invoke the operation of model generating microservice, e.g., microservice 4016I which can be a dedicated model generating microservice dedicated to generating interoperable models which can be stored into data repository 108 to facilitate later reuse of the interoperable models by manager system 110 as candidate multi-model output supporting template models for presentment in subsequent prompting data to a second user and any other subsequent user. In one embodiment, responsively to receipt of model configuration data from a user defining a custom model design, multiple proprietary format models of different formatting can be generated according to the custom design and sent to a user for integration into targeted enterprise model rendering systems, while an interoperable format model according to the custom model design is also generated and stored into data repository 108 to facilitate referencing of the interoperable model by manager system 110 in selectable prompting data within a user interface 3000 delivered to a second user to facilitate selection of the interoperable model as a template model by the second user in support of a new custom model design by the second user. The interoperable model in one embodiment need not be delivered to a user (unless required by a target rendering system). Flags having the string “FLAG” can specify the generation of a multi-model output supporting models, and such flags can be carried forward in hierarchical strings of models. The indicated flag serial number shown, MM037 can specify a specific set of enabled enterprise model rendering systems. For example, a first interoperable model might be configured to be rendered on a first more expansive set of enterprise model rendering systems, and second interoperable model might be configured to be rendered on a second less expansive set of enterprise model rendering systems. Manager system 110 in generating prompting data defined by menu options that specify multiple available enterprise rendering systems for use by a user to select target enterprise model rendering systems can examine the described serial number that indicates the set of enabled enterprise model rendering systems.

There is set forth herein, according to one embodiment, model configuration data, wherein the model configuration data from the user references a first identifier for a first enterprise model generating system, a second identifier for a second enterprise model generating system, and a third identifier specifying a flag (e.g., the described ID-FLAG_MM037) for triggering generation of an interoperable model, wherein the method includes examining the first identifier, the second identifier, and the third identifier, wherein the method includes publishing a first model generating request having a first classification tag to a microservices message bus 4014, the first classification tag determined in dependence on the first identifier, publishing a second model generating request having a second classification tag to the microservices message bus 4014, the second classification tag determined in dependence on the second identifier, and publishing a third model generating request having a third classification tag to the microservices message bus, the third classification tag determined in dependence on the third identifier, wherein the first classification tag invokes operation by a first microservice to generate the first object representing model, wherein the second classification tag invokes operation of a second microservice to generate the second object representing model, wherein the first object representing model is configured to be rendered on a first enterprise model rendering system, e.g., 140J in the described example, wherein the second object representing model is configured to be rendered on a second enterprise model rendering system, e.g., 140K in the described example, wherein the third classification tag invokes operation by a third microservice e.g., 4016I in the described example, to generate a third object representing model according to the custom model design of the user, wherein the third object representing model is of an interoperable file format, e.g., .glb, different from a file format of the first object representing model and different from a file format of the second object representing model, and wherein the third microservice is configured to simultaneously adhere to model design requirements of the first enterprise model rendering system and the second enterprise model rendering system when generating the third object representing model of the interoperable file format, and wherein the model design requirements adhered to by the third microservice include, in one embodiment, model design requirements of file size, number of polygons, number of vertices, and bone structure.

There is set forth herein, in one embodiment, a method that include generating prompting data for prompting a user to define configuration data that specifies a configuration for an object representing model, wherein the prompting data references a set of candidate models that are selectable by the user; presenting the prompting data to the user, wherein the prompting data references the set of candidate models that are selectable by the user, e.g., as shown by the model representations 3002A-3002Z of user interface 3000 as shown in FIG. 4A; receiving model configuration data from the user subsequent to the presenting the prompting data, wherein the model configuration data received from the user specifies a model from set of candidate models which has been selected by the user in response to data of the prompting data; generating an object representing model using the model configuration data received from the user; and sending the generated object representing model to the user. In one embodiment, the set of candidate models includes one or more model previously designed by a second user of the system of system 100. The second user in one embodiment can be a user who has configured the one or model using a user interface 3000 configured according to user interface 3000 and having features set forth in reference to user interface 3000 described in reference to FIGS. 4A-4E.

Various available tools, libraries, and/or services can be utilized for implementation of predictive models herein such as predictive model 3072 and/or predictive model 3074. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, and monitoring and retraining deployed models. According to one possible implementation, a machine learning service can provide access to machine learning support libraries of APACHE® SPARK®. APACHE® and SPARK® are registered trademarks of the Apache Software Foundation. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, and monitoring and retraining deployed models. Predictive models herein such as predictive model 3072 and/or predictive model 3074 can employ use of, e.g., neural networks, support vector machines (SVM), Bayesian networks, random forests, regression analytics, Fourier curve fitting and/or other machine learning technologies.

Certain embodiments herein may offer technical effects, including technical computing advantages computing advantages including advantages to address problems arising in the realm of computer systems. Embodiments herein can include user interface acceleration features for accelerating the operation of a user interface, e.g., for improvement in the speed with which communication content is configured by user and the accuracy with which the user communicates desired information. Embodiments herein can feature the delivery to a user of prompting data that prompts the user to select attributes of a model such as two-dimensional or three-dimensional model. The prompting data delivered to users can be intelligently selected. For example, prompting data can be adapted in dependence user profile data of user, which user profile data can include data on preferences of the user. In one aspect, prompting data delivered to a user can specify candidate prestored models for selection by a user. The selected prior stored models can define building blocks toward a user's defining of finalized model configuration data defining a finalized custom design of the user. In one example, prompting data can present candidate models, and by selection of a candidate model from the candidate models the user can specify a template model that can serve as a basis for development of a new custom model design. Prompting data in one aspect can crowdsource driven. In one example, the likelihood of presentation of a certain model as selectable candidate model can increase with usage of the certain model by system users. In such manner, a user can benefit from crowdsourced evaluations of custom model designs. The candidate models can include, e.g., system models that are not associated to any user and/or user associated models that are associated to a certain second user of the described system. The certain second user can be selected in dependence on user profile data of the second user having a threshold satisfying level of similarity with the user profile of the current user. Embodiments herein facilitate, with user an intuitive menu driven user interface a range of model customizations of an in-draft model including adding accessories to modify object shape representing data of model data, and adding texture. Embodiments herein can facilitate accessory removal of an in-draft model with generation of prompting data that presents on presentment in hierarchical order selectable prior stored precursor versions of an in-draft model. Embodiments herein can include, in response to the user providing user defined model configuration data, generating a model according to the model configuration of a user. For generating a model according to user defined model configuration data, there can be provided a plurality of microservices wherein respective ones of the model generating microservices are configured to generate a model in a specified model format associated to a certain enterprise model rendering system out of a set of enterprise model rendering systems. In one embodiment, a model generating request comprising asset data associated to a user's model configuration data and tagged with a classification tag can be published to a microservices message bus. Different respective model generating microservices can be interrogating the microservices system bus and one or more microservices of the set of microservices subscribing to the classification tag can be triggered to process the message data. In another aspect, different model generating microservices can be iteratively updated with use of a revisioning process in which model specification documents are iteratively parsed for determination of process modifications of the described model generating microservices.

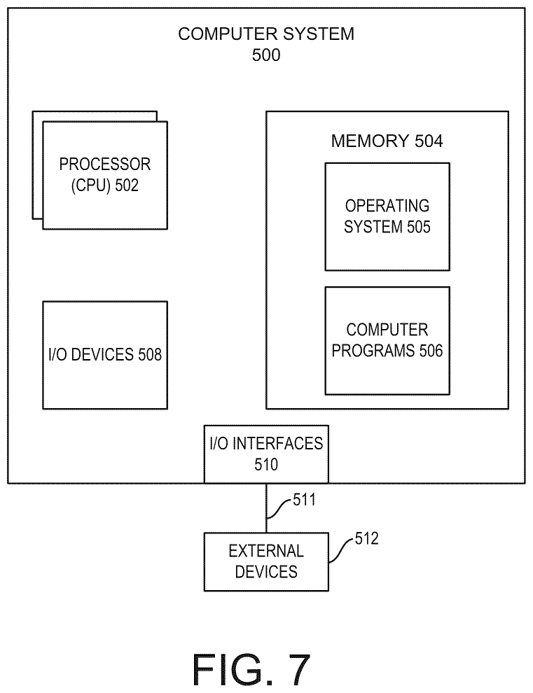

Processes described herein may be performed singly or collectively by one or more computer systems, such as one or more for executing secured program code. FIG. 7 depicts one example of such a computer system and associated devices to incorporate and/or use aspects described herein. A computer system may also be referred to herein as a data processing device/system, computing device/system/node, or simply a computer. The computer system may be based on one or more of various system architectures and/or instruction set architectures, such as those offered by Intel Corporation (Santa Clara, California, USA) or ARM Holdings plc (Cambridge, England, United Kingdom), as examples. FIG. 7 shows a computer system 500 in communication with external device(s) 512. Computer system 500 includes one or more processor(s) 502, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 502 can also include register(s) to be used by one or more of the functional components. Computer system 500 also includes memory 504, input/output (I/O) devices 508, and I/O interfaces 510, which may be coupled to processor(s) 502 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 504 can be or include main or system memory (e.g., Random Access Memory) used in the execution of program instructions, storage device(s) such as hard drive(s), flash media, or optical media as examples, and/or cache memory, as examples. Memory 504 can include, for instance, a cache, such as a shared cache, which may be coupled to local caches (examples include L1 cache, L2 cache, etc.) of processor(s) 502. Additionally, memory 504 may be or include at least one computer program product having a set (e.g., at least one) of program modules, instructions, code or the like that is/are configured to carry out functions of embodiments described herein when executed by one or more processors. Memory 504 can store an operating system 505 and other computer programs 506, such as one or more computer programs/applications that execute to perform aspects described herein. Specifically, programs/applications can include computer readable program instructions that may be configured to carry out functions of embodiments of aspects described herein. Examples of I/O devices 508 include but are not limited to microphones, speakers, Global Positioning System (GPS) devices, cameras, lights, accelerometers, gyroscopes, magnetometers, sensor devices configured to sense light, proximity, heart rate, body and/or ambient temperature, blood pressure, and/or skin resistance, and activity monitors. An I/O device may be incorporated into the computer system as shown, though in some embodiments an I/O device may be regarded as an external device (512) coupled to the computer system through one or more I/O interfaces 510.

Computer system 500 may communicate with one or more external devices 512 via one or more I/O interfaces 510. Example external devices include a keyboard, a pointing device, a display, and/or any other devices that enable a user to interact with computer system 500. Other example external devices include any device that enables computer system 500 to communicate with one or more other computing systems or peripheral devices such as a printer. A network interface/adapter is an example I/O interface that enables computer system 500 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems (BLUETOOTH is a registered trademark of Bluetooth SIG, Inc., Kirkland, Washington, U.S.A.). The communication between I/O interfaces 510 and external devices 512 can occur across wired and/or wireless communications link(s) 511, such as Ethernet-based wired or wireless connections. Example wireless connections include cellular, Wi-Fi, Bluetooth®, proximity-based, near-field, or other types of wireless connections. More generally, communications link(s) 511 may be any appropriate wireless and/or wired communication link(s) for communicating data. Particular external device(s) 412 may include one or more data storage devices, which may store one or more programs, one or more computer readable program instructions, and/or data, etc.

Computer system 500 may include and/or be coupled to and in communication with (e.g., as an external device of the computer system) removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. Computer system 500 may be operational with numerous other general purpose or special purpose computing system environments or configurations. Computer system 500 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Aspects of the present invention may be a system, a method, and/or a computer program product, any of which may be configured to perform or facilitate aspects described herein. In some embodiments, aspects of the present invention may take the form of a computer program product, which may be embodied as computer readable medium(s). A computer readable medium may be a tangible storage device/medium having computer readable program code/instructions stored thereon. Example computer readable medium(s) include, but are not limited to, electronic, magnetic, optical, or semiconductor storage devices or systems, or any combination of the foregoing. Example embodiments of a computer readable medium include a hard drive or other mass-storage device, an electrical connection having wires, random access memory (RAM), read-only memory (ROM), erasable-programmable read-only memory such as EPROM or flash memory, an optical fiber, a portable computer disk/diskette, such as a compact disc read-only memory (CD-ROM) or Digital Versatile Disc (DVD), an optical storage device, a magnetic storage device, or any combination of the foregoing. The computer readable medium may be readable by a processor, processing unit, or the like, to obtain data (e.g., instructions) from the medium for execution. In a particular example, a computer program product is or includes one or more computer readable media that includes/stores computer readable program code to provide and facilitate one or more aspects described herein. As noted, program instruction contained or stored in/on a computer readable medium can be obtained and executed by any of various suitable components such as a processor of a computer system to cause the computer system to behave and function in a particular manner. Such program instructions for carrying out operations to perform, achieve, or facilitate aspects described herein may be written in, or compiled from code written in, any desired programming language. In some embodiments, such programming language includes object-oriented and/or procedural programming languages such as C, C++, C#, Java, etc. Program code can include one or more program instructions obtained for execution by one or more processors. Computer program instructions may be provided to one or more processors of, e.g., one or more computer systems, to produce a machine, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions. Although various embodiments are described above, these are only examples. For example, computing environments of other architectures can be used to incorporate and use one or more embodiments.

As noted, computer systems herein including computer systems defining manager system 110 can be defined in a cloud computing environment. Cloud computing is a model for enabling ubiquitous, convenient, on-demand network access to a shared pool of configurable computing resources (e.g., networks, servers, storage, applications, and services) that can be rapidly provisioned and released with minimal management effort or service provider interaction. This cloud model can be composed of five baseline characteristics, three service models, and four deployment models. Baseline Characteristics-On-demand self-service. A consumer can unilaterally provision computing capabilities, such as server time and network storage, as needed automatically without requiring human interaction with each service provider. Broad network access. Capabilities are available over the network and accessed through standard mechanisms that promote use by heterogeneous thin or thick client platforms (e.g., mobile phones, tablets, laptops, and workstations). Resource pooling. The provider's computing resources are pooled to serve multiple consumers using a multi-tenant model, with different physical and virtual resources dynamically assigned and reassigned according to consumer demand. There can be a sense of location independence in that the customer generally has no control or knowledge over the exact location of the provided resources but may be able to specify location at a higher level of abstraction (e.g., country, state, or datacenter). Examples of resources include storage, processing, memory, and network bandwidth. Rapid elasticity. Capabilities can be elastically provisioned and released, in some cases automatically, to scale rapidly outward and inward commensurate with demand. To the consumer, the capabilities available for provisioning often appear to be unlimited and can be appropriated in any quantity at any time. Measured service. Cloud systems automatically control and optimize resource use by leveraging a metering capability (Typically this can be done on a pay-per-use or charge-per-use basis) at some level of abstraction appropriate to the type of service (e.g., storage, processing, bandwidth, and active user accounts). Resource usage can be monitored, controlled, and reported, providing transparency for both the provider and consumer of the utilized service. Service Models—Software as a Service (SaaS). The capability provided to the consumer is to use the provider's applications running on a cloud infrastructure. A cloud infrastructure can include a collection of hardware and software that enables the five essential characteristics of cloud computing. The cloud infrastructure can be viewed as containing both a physical layer and an abstraction layer. The physical layer consists of the hardware resources that are necessary to support the cloud services being provided, and typically includes server, storage and network components. The abstraction layer consists of the software deployed across the physical layer, which manifests the essential cloud characteristics. Conceptually the abstraction layer sits above the physical layer. The applications are accessible from various client devices through either a thin client interface, such as a web browser (e.g., web-based email), or a program interface. The consumer does not manage or control the underlying cloud infrastructure including network, servers, operating systems, storage, or even individual application capabilities, with the possible exception of limited user-specific application configuration settings. Platform as a Service (PaaS). The capability provided to the consumer is to deploy onto the cloud infrastructure consumer-created or acquired applications created using programming languages, libraries, services, and tools supported by the provider. This capability does not necessarily preclude the use of compatible programming languages, libraries, services, and tools from other sources. The consumer does not manage or control the underlying cloud infrastructure including network, servers, operating systems, or storage, but has control over the deployed applications and possibly configuration settings for the application-hosting environment. Infrastructure as a Service (IaaS). The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, and deployed applications; and possibly limited control of select networking components (e.g., host firewalls). Deployment Models—Private cloud. The cloud infrastructure can be provisioned for exclusive use by a single organization comprising multiple consumers (e.g., business units). It may be owned, managed, and operated by the organization, a third party, or some combination of them, and it may exist on or off premises. Community cloud. The cloud infrastructure can be provisioned for exclusive use by a specific community of consumers from organizations that have shared concerns (e.g., mission, security requirements, policy, and compliance considerations). It may be owned, managed, and operated by one or more of the organizations in the community, a third party, or some combination of them, and it may exist on or off premises. Public cloud. The cloud infrastructure can be provisioned for open use by the general public. It may be owned, managed, and operated by a business, academic, or government organization, or some combination of them. It exists on the premises of the cloud provider. Hybrid cloud. The cloud infrastructure can be a composition of two or more distinct cloud infrastructures (private, community, or public) that remain unique entities, but are bound together by standardized or proprietary technology that enables data and application portability (e.g., cloud bursting for load balancing between clouds).

This written description uses examples to disclose the subject matter, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is to be understood that the above description is intended to be illustrative, and not restrictive. For example, the above-described examples (and/or aspects thereof) may be used in combination with each other. In addition, many modifications may be made to adapt a particular situation or material to the teachings of the various examples without departing from their scope. While the dimensions and types of materials described herein are intended to define the parameters of the various examples, they are by no means limiting and are merely exemplary. Many other examples will be apparent to those of skill in the art upon reviewing the above description. The scope of the various examples should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Forms of term “based on” herein encompass relationships where an element is partially based on as well as relationships where an element is entirely based on. Forms of the term “defined” encompass relationships where an element is partially defined as well as relationships where an element is entirely defined. Further, the limitations of the following claims are not written in means-plus-function format and are not intended to be interpreted based on the 35 U.S.C. § 112(f), unless and until such claim limitations expressly use the phrase “means for” followed by a statement of function void of further structure. It is to be understood that not necessarily all such objects or advantages described above may be achieved in accordance with any particular example. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the subject matter has been described in detail in connection with only a limited number of examples, it should be readily understood that the subject matter is not limited to such disclosed examples. Rather, the subject matter can be modified to incorporate any number of variations, alterations, substitutions or equivalent arrangements not heretofore described, but which are commensurate with the spirit and scope of the subject matter. Additionally, while various examples of the subject matter have been described, it is to be understood that aspects of the disclosure may include only some of the described examples. Also, while some examples are described as having a certain number of elements it will be understood that the subject matter can be practiced with less than or greater than the certain number of elements. Accordingly, the subject matter is not to be seen as limited by the foregoing description but is only limited by the scope of the appended claims.

1. A computer implemented method comprising:
generating, by a system, prompting data for prompting a user of the system to define configuration data that specifies a model configuration, wherein the prompting data references a set of candidate models that are selectable by the user;
presenting the prompting data to the user, wherein the prompting data references the set of candidate models that are selectable by the user;
receiving model configuration data from the user subsequent to the presenting the prompting data, wherein the model configuration data received from the user specifies a custom model design of the user and references a previously stored model, which previously stored model, in response to data of the prompting data, has been selected as a template model for use in providing the custom model design of the user;
generating an object representing model using data of the model configuration data received from the user; and
sending the generated object representing model to the user.

2. (canceled)

3. (canceled)

4. The computer implemented method of claim 1, wherein model configuration data received from the user references at least one surface property customization of the user, and wherein the model configuration data received from the user references at least one accessory customization of the user.

5. (canceled)

6. The computer implemented method of claim 1, wherein the method includes storing a certain model according to the custom model design into a data repository; evaluating the certain model for inclusion in a candidate set of candidate models for presentment to a second user of the system; and presenting subsequent prompting data to the second user in response to a determination from the evaluating that a criterion has been satisfied, wherein the subsequent prompting data presented to the second user references the certain model.

7. (canceled)

8. (canceled)

9. The computer implemented method of claim 1, wherein the method includes storing a certain model according to the custom model design of the user into a data repository; evaluating the certain model for inclusion in a candidate set of candidate models for presentment to a second user of the system; presenting subsequent prompting data to the second user in response to a determination from the evaluating that a criterion has been satisfied, wherein the subsequent prompting data presented to the second user references the certain model; receiving subsequent model configuration data from the second user, wherein the subsequent model configuration data specifies a subsequent custom model design of the second user and references the custom model design of the user as a selected template model for use in developing the subsequent custom model design by the second user, wherein the evaluating is dependent on a result of (a) subjecting asset data of the user to natural language processing and (b) subjecting asset data of the second user to natural language processing.

10. The computer implemented method of claim 1, wherein the method includes storing a certain model according to the custom model design of the user into a data repository; evaluating the certain model for inclusion in a candidate set of candidate models for presentment to a second user of the system; presenting subsequent prompting data to the second user in response to a determination from the evaluating that a criterion has been satisfied, wherein the subsequent prompting data presented to the second user references the certain model; receiving subsequent model configuration data from the second user, wherein the subsequent model configuration data specifies a subsequent custom model design of the second user and references the custom model design of the user as a selected template model for use in developing the subsequent custom model design by the second user, wherein the method includes, after the storing, maintaining a count of instances in which other users of the system have selected the certain model as a template model on which to base development of their respective custom model designs, and wherein the evaluating is dependent on the count of instances in which other users of the system have selected the certain model as a template model on which to base development of their respective custom model designs.

11. The computer implemented method of claim 1, wherein the method includes storing a certain model according to the custom model design of the user into a data repository; evaluating the certain model for inclusion in a candidate set of candidate models for presentment to a second user of the system; presenting subsequent prompting data to the second user in response to a determination from the evaluating that a criterion has been satisfied, wherein the subsequent prompting data presented to the second user references the certain model; receiving subsequent model configuration data from the second user, wherein the subsequent model configuration data specifies a subsequent custom model design of the second user and references the custom model design of the user as a selected template model for use in developing the subsequent custom model design by the second user, wherein the evaluating is dependent on a result of (a) subjecting asset data of the user to natural language processing for extraction of topic and sentiment parameter values and (b) subjecting asset data of the second user to natural language processing for extraction of topic and sentiment parameter values.

12. (canceled)

13. (canceled)

14. The computer implemented method of claim 1, wherein the set of candidate models includes a previously-designed model previously designed by a second user of the system, wherein the prompting data further references menu options for defining customized model surface properties, wherein the method includes determining user profile data of the user and wherein the generating the prompting data includes selecting the set of candidate models for referencing in the prompting data including the previously-designed model previously designed by the second user of the system, and selecting the menu options for defining customized model surface properties in dependence on the user profile data of the user.

15. (canceled)

16. (canceled)

17. The computer implemented method of claim 1, wherein the method includes (a) interrogating a microservices message bus by a first model generating microservice that generates formatted models formatted according to a first file format to be rendered on a first enterprise model rendering system, wherein the first model generating microservice has subscribed to messages published to the microservices bus having a first classification tag; (b) interrogating the microservices message bus by a second model generating microservice that generates formatted models formatted according to a second file format to be rendered on a second enterprise model rendering system; (c) publishing a message having the first classification tag to the microservices bus in response to the receiving the model configuration data; and responsively to the publishing, (d) performing the generating the object representing model by the first model generating microservice that generates formatted models formatted according to a first file format to be rendered on the first enterprise model rendering system.

18. (canceled)

19. The computer implemented method of claim 1, wherein the method includes presenting subsequent prompting data to a second user of the system, wherein the prompting data presented to the second user includes a model representation for selection by the second user that represents a stored model in accordance with the custom model design of the user, wherein the method includes receiving second model configuration data from the second user, the second model configuration data including a reference to the stored model according to the custom design of the user selected as a template model by the second user for development of a subsequent custom model design by the second user.

20. The computer implemented method of claim 1, wherein the method includes iteratively storing into a data repository instances of model configuration data specifying custom model designs from multiple second users of the system, wherein the instances respectively include a reference to a template model used for providing the respective custom model design, and wherein one of the instances of the model configuration data references a certain stored model of the data repository according to the custom model design of the user as a template model, wherein the method includes presenting further prompting data to a further user, wherein the further prompting data presents multiple selectable model representations in a hierarchical order, the hierarchical order determined in dependence on a respective template model referenced in the respective represented models of the hierarchical order so that models represented in the hierarchical order are represented in a lower hierarchical order than a referenced template model that they reference, wherein the multiple selectable model representations in a hierarchical order are active to permit selection by the further user of any one of the multiple selectable model representation to specify a template model for use in providing a custom model design of the further user.

21. (canceled)

22. The computer implemented method of claim 1, wherein the prompting data presents multiple selectable model representations in a hierarchical order, the multiple selectable model representations in the hierarchical order depicting a hierarchical relationship between at least one model and at least one template model associated to and used as a base to provide a customized model design defined by the at least one model, wherein the model representation of the at least one template model is depicted in higher order hierarchy relative to the model representation of the at least one model, wherein the model representation of the at least one template model is depicted to have a removed accessory relative to the model representation of the at least one model, wherein the multiple selectable model representations in the hierarchical order are active to permit selection by the user of respective ones of the multiple selectable model representations to specify the template model for use in providing the custom model design of the user, and wherein the model configuration data specifies selection of the at least one template model as the template model for use in providing the custom model design of the user.

23. The computer implemented method of claim 1, wherein the method includes generating a second object representing model in response to receiving configuration data of the model configuration data from the user, wherein the generating the object representing model and the generating the second object representing model includes invoking in response to the receiving model configuration data from the user, operation of a first microservice for generating the object representing model, and invoking in response to the receiving model configuration data from the user operation of a second microservice for generating the second object representing model, wherein the object representing model is configured to be rendered on a first enterprise model rendering system, and wherein the second object representing model is configured to be rendered on a second enterprise model rendering system.

24. (canceled)

25. (canceled)

26. A computer implemented method comprising:
generating, by a system, prompting data for prompting a user of the system to define configuration data that specifies a model configuration;
presenting the prompting data to the user;
receiving model configuration data from the user subsequent to the presenting the prompting data, wherein the model configuration data received from the user specifies a custom model design of the user and references a previously stored model, which previously stored model, in response to data of the prompting data, has been selected as a template model for use in providing the custom model design;
generating a first object representing model and a second object representing model according to the custom model design of the user using data of the model configuration data received from the user; and
sending the first object representing model and the second object representing model to the user.

27. (canceled)

28. (canceled)

29. The computer implemented method of claim 26, wherein model configuration data received from the user references at least one surface property customization of the user, and wherein the model configuration data received from the user references at least one accessory customization of the user.

30. (canceled)

31. The computer implemented method of claim 26, wherein the generating first and second object representing models includes generating the first object representing model in a first model file format and generating the second object representing model in a second model file format, and wherein the previously stored model selected by the user as a template model is of model file format different from the first model file format and the second model file format.

32. (canceled)

33. The computer implemented method of claim 26, wherein the generating first and second object representing models includes invoking in response to the receiving model configuration data from the user, operation of a first microservice for generating the first object representing model, and invoking in response to the receiving model configuration data from the user operation of a second microservice for generating the first object representing model, wherein the first object representing model is configured to be rendered on a first enterprise model rendering system, and wherein the second object representing model is configured to be rendered on a second enterprise model rendering system.

34. (canceled)

35. (canceled)

36. The computer implemented method of claim 26, wherein the model configuration data from the user references a first identifier for a first enterprise model generating system, a second identifier for a second enterprise model generating system, and a third identifier specifying a flag for triggering generation of an interoperable model, wherein the method includes examining the first identifier, the second identifier, and the third identifier, wherein the method includes publishing a first model generating request having a first classification tag to a microservices message bus, the first classification tag determined in dependence on the first identifier, publishing a second model generating request having a second classification tag to the microservices message bus, the second classification tag determined in dependence on the second identifier, and publishing a third model generating request having a third classification tag to the microservices message bus, the third classification tag determined in dependence on the third identifier, wherein the first classification tag invokes operation by a first microservice to generate the first object representing model, wherein the second classification tag invokes operation of a second microservice to generate the second object representing model, wherein the first object representing model is configured to be rendered on a first enterprise model rendering system, wherein the second object representing model is configured to be rendered on a second enterprise model rendering system, wherein the third classification tag invokes operation by a third microservice to generate a third object representing model according to the custom model design of the user, wherein the third object representing model is of an interoperable file format different from a file format of the first object representing model and different from a file format of the second object representing model, and wherein the third microservice is configured to simultaneously adhere to model design requirements of the first enterprise model rendering system and the second enterprise model rendering system when generating the third object representing model of the interoperable file format.

37. The computer implemented method of claim 26, wherein the model configuration data from the user references a first identifier for a first enterprise model generating system, a second identifier for a second enterprise model generating system, and a third identifier specifying a flag for triggering generation of an interoperable model, wherein the method includes examining the first identifier, the second identifier, and the third identifier, wherein the method includes publishing a first model generating request having a first classification tag to a microservices message bus, the first classification tag determined in dependence on the first identifier, publishing a second model generating request having a second classification tag to the microservices message bus, the second classification tag determined in dependence on the second identifier, and publishing a third model generating request having a third classification tag to the microservices message bus, the third classification tag determined in dependence on the third identifier, wherein the first classification tag invokes operation by a first microservice to generate the first object representing model, wherein the second classification tag invokes operation of a second microservice to generate the second object representing model, wherein the first object representing model is configured to be rendered on a first enterprise model rendering system, wherein the second object representing model is configured to be rendered on a second enterprise model rendering system, wherein the third classification tag invokes operation by a third microservice to generate a third object representing model according to the custom model design of the user, wherein the third object representing model is of an interoperable file format different from a file format of the first object representing model and different from a file format of the second object representing model, and wherein the third microservice is configured to simultaneously adhere to model design requirements of the first enterprise model rendering system and the second enterprise model rendering system when generating the third object representing model of the interoperable file format, and wherein the model design requirements adhered to by the third microservice include model design requirements of file size, number of polygons, number of vertices, and bone structure.

38. (canceled)

39. The computer implemented method of claim 26, wherein the method includes presenting prompting data to a second user of the system, wherein the prompting data presented to the second user includes a model representation for selection by the second user that represents a stored model in accordance with the customized design of the user.

40. The computer implemented method of claim 26, wherein the method includes presenting prompting data to a second user of the system, wherein the prompting data presented to the second user includes a model representation for selection by the second user that represents a stored model in accordance with the customized design of the user, wherein the method includes receiving second model configuration data from the second user, the second model configuration data including an identifier of the stored model selected as a template model by the second user for development of a custom model design by the second user.

41. The computer implemented method of claim 26, wherein the method includes presenting prompting data to a second user of the system, wherein the prompting data presented to the second user includes a model representation for selection by the second user that represents a stored model in accordance with the customized design of the user, wherein the method includes receiving second model configuration data from the second user, the second model configuration data including an identifier of the stored model selected as a template model by the second user for development of a custom model design by the second user, wherein the generating first and second object representing models includes generating the first object representing model in a first model file format and generating the second object representing model in a second model file format, and wherein the model selected by the user as a template model is of model file format different from the first model file format and the second model file format, wherein the generating first and second object representing models includes invoking in response to the receiving model configuration data from the user, operation of a first microservice for generating the first object representing model, and invoking in response to the receiving model configuration data from the user operation of a second microservice for generating the first object representing model.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)
